(19) United States
(12) Patent Application Publication
(10) Pub. No.: US 2011/0307273 A1
(43) Pub. Date: Dec. 15, 2011

(54) TRACKING TREATMENT SEQUENCES IN HEALTH CARE

(76) Inventors: Albert B. Barabas, Fitchburg, WI (US); Robert J. Rothwell, IV, Columbus, OH (US)

(21) Appl. No.: 12/813,809

(22) Filed: Jun. 11, 2010

(51) Int. Cl. G06Q 50/00; G06Q 10/00

(52) U.S. Cl. 705/3

(57) ABSTRACT

Among other things, a data model is used to express possible sequences of steps related to treatment of patients and corresponding results of respective sequences in accordance with a health care algorithm.

### BACKGROUND

This description relates to tracking of treatment sequences in health care.

In health care, there are accepted standard procedures for administering medical treatment that relate directly to the quality of care received by patients. Providing standard medical treatment correctly leads to fewer bad outcomes. To aid hospitals to measure how well they are adhering to the standards, flowcharts have been created that define, in algorithmic terms, accepted procedures for certain treatment scenarios.

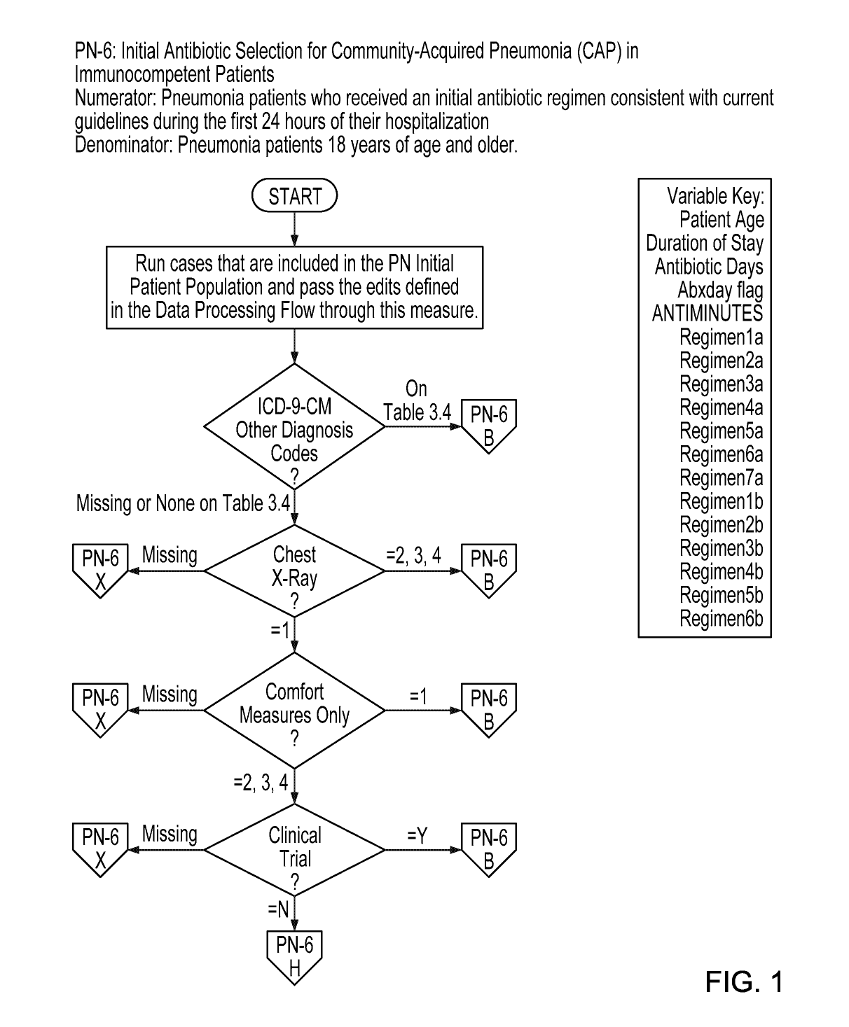

These algorithms generally are created either by an individual health care organization or by a regulatory body. In 1999, The Joint Commission began to create standards by which hospitals could be rated. In conjunction with Centers for Medicare & Medicaid Services, medical treatment standards were developed and published in the Specifications Manual for National Hospital Quality Measures. Different categories of these algorithms (flowcharts) cover different fields of health care. Each category has several flowcharts. The size and complexity of these flowcharts is illustrated by the first page of the algorithm Pneumonia-6 (PN-6) in the Specifications Manual for National Hospital Quality Measures (FIG. 1).

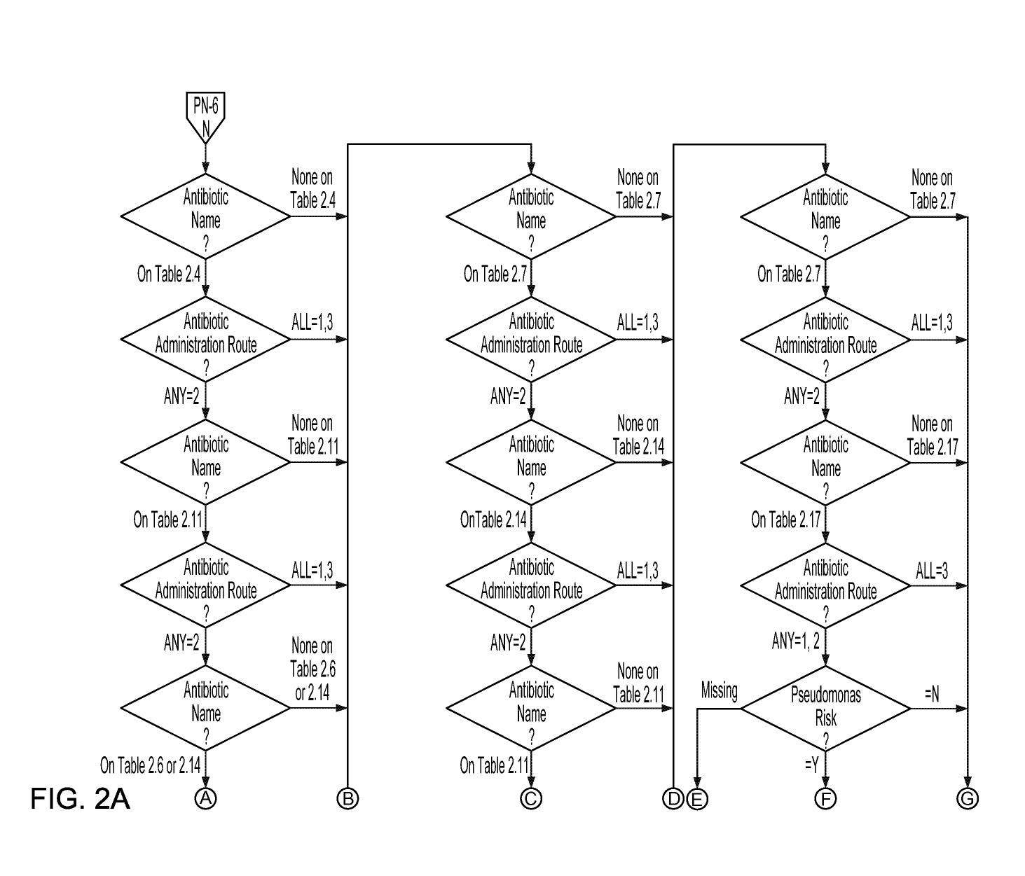

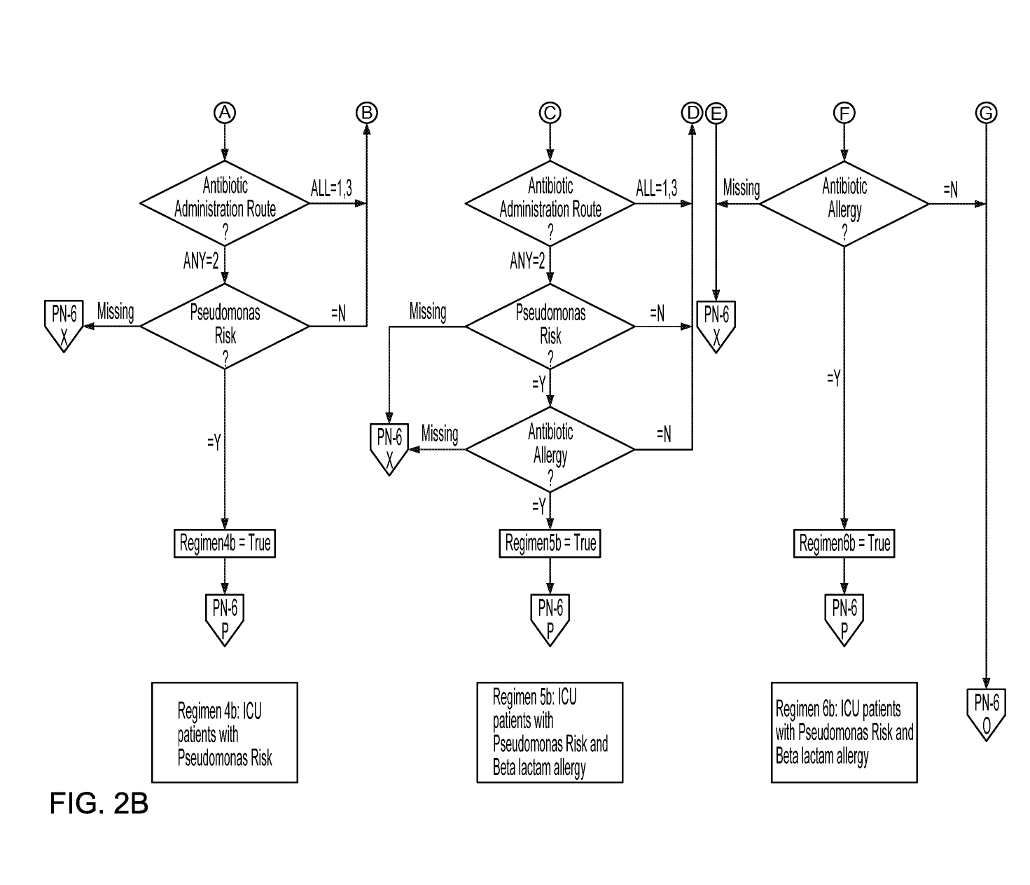

The steps of the algorithms include decision points or steps in medical treatment. At each decision point, which is represented as a node, a question must be answered to proceed, for example, whether instructions were issued to a heart failure patient upon discharge from the hospital. The path traversed through the nodes of the flow chart as each question is answered determines the overall outcome (or conclusion of the algorithm) expressed as a letter, such as E, D, and B, to indicate whether proper care was given, proper care was not given, or the patient case does not apply to the given algorithm. A flowchart can be many pages long. FIGS. 2A and 2B show the eighth page of the flowchart representing the algorithm Pneumonia-6.

The questions at the nodes of the flowchart range in types from calculations to use of standard tables. If an answer at a step is outside acceptable parameters, then the algorithm continues on a path that could result in a hospital being scored a failure for that case of patient care. A hospital that proceeds through the algorithm, remaining within acceptable parameters, is scored a pass for that case of patient care.

These algorithms are categorized into sets, known as measures, based upon the type of medical treatment, for example, heart failure. Both The Joint Commission and Centers for Medicare & Medicaid Services issue a grade for each measure group. This grade relates to an overall percentage of all applicable patient cases for that measure for which the patient cases were passing.

If causes of medical errors are clearer to hospitals, then the causes can be addressed. Better analysis of treatment failures helps hospitals to reevaluate policies and procedures to reduce errors.

### SUMMARY

In general, in an aspect, a data model is used to express possible sequences of steps related to treatment of patients and corresponding results of respective sequences in accordance with a healthcare algorithm.

Implementations may include one or more of the following features. The data model comprises a meta-model of a real-world model that is represented by the algorithm. The algorithm is expressed as a flow chart. The data model is used to express such sequences and results in accordance with more than one predefined algorithm. The model includes object-oriented program objects. Patient cases are processed using the data model with respect to the treatment algorithm to determine the sequences to which the patient cases belong, and the corresponding results are used to analyze causes of outcomes of the cases. The using of the data model includes expressing each of the steps as an encapsulated step object that represents a branching point of the possible sequences. Using the data model comprises including expected answers to a question that corresponds to each of the steps. Using the data model comprises including identifications of next treatment steps corresponding to respective expected answers. Using the data model comprises including a type of expected answers for questions associated with the steps. The algorithm comprises a treatment algorithm and the steps comprise treatment steps. The algorithm comprises steps to determine when a patient is in a given population. The algorithm comprises steps to check quality of data. The algorithm comprises an embedded sub-algorithm. The data model expresses possible sequences of steps, consistently for interaction by a user, in accordance with at least two of a treatment algorithm, a data quality check algorithm, a within-population checking algorithm, and an algorithmic-choice algorithm.

In general, in an aspect, for patients, whose treatment outcomes result from sequences of treatment steps traversed through a treatment algorithm, forming a data record for each of the patients that includes (a) the sequence of treatment steps for the patient and (b) a result of the sequence that corresponds to the outcome for the patient.

Implementations may include enabling an interface user to use the data records for groups of patients whose treatments traversed respective sequences through the treatment algorithm to obtain information indicative of causes of outcomes that correspond to respective treatment sequences.

In general, in an aspect, a medium bears a data structure that can be used by a computer to define possible sequences of steps related to treatment of patients and corresponding results of the respective sequences.

In general, in an aspect, patient-treatment-related cases are categorized among a set of different possible sequences of steps and related outcomes, based on data structures that were derived from standard pre-defined sequences and outcomes. A user can manipulate the categories of patient-treatment-related cases to infer causes of the outcomes.

These and other aspects and features, and combinations of them, can be expressed as methods, apparatus, systems, components, program products, means for performing functions, business methods, and in other ways.

Other aspects and features will become apparent from the following description and from the claims.

### DESCRIPTION

FIGS. 1, 2A, and 2B are excerpts from Centers for Medicare & Medicaid Services' and The Joint Commission's Specifications Manual for National Hospital Quality Measures, version 3.0.

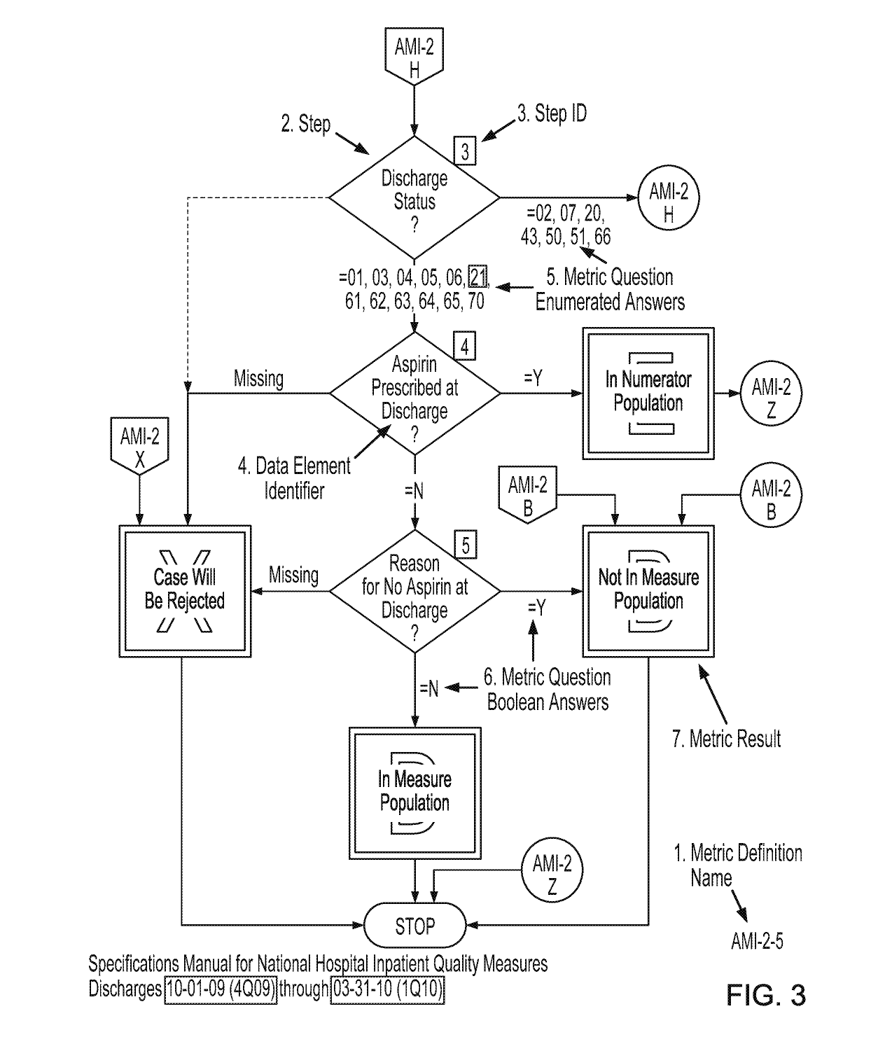

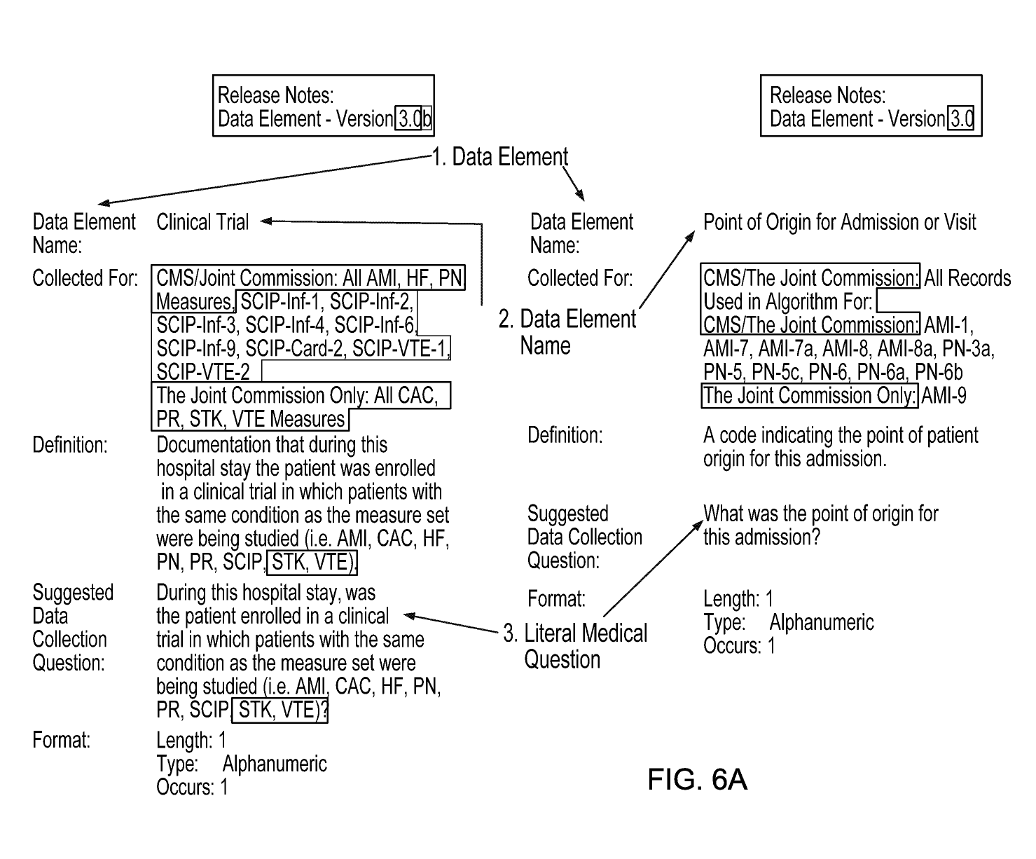

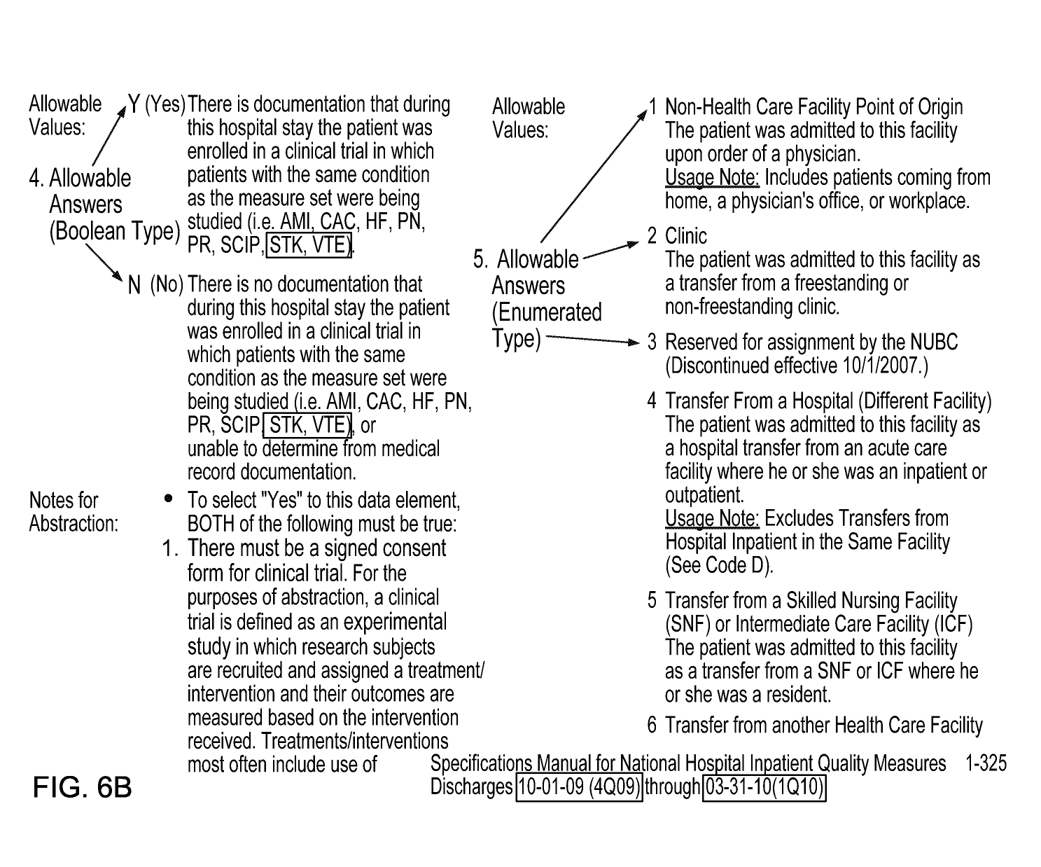

FIGS. 3, 6A, and 6B are annotated excerpts from the Specifications Manual for National Hospital Quality Measures illustrating how a failure tracking system can be connected to these health care specific algorithms.

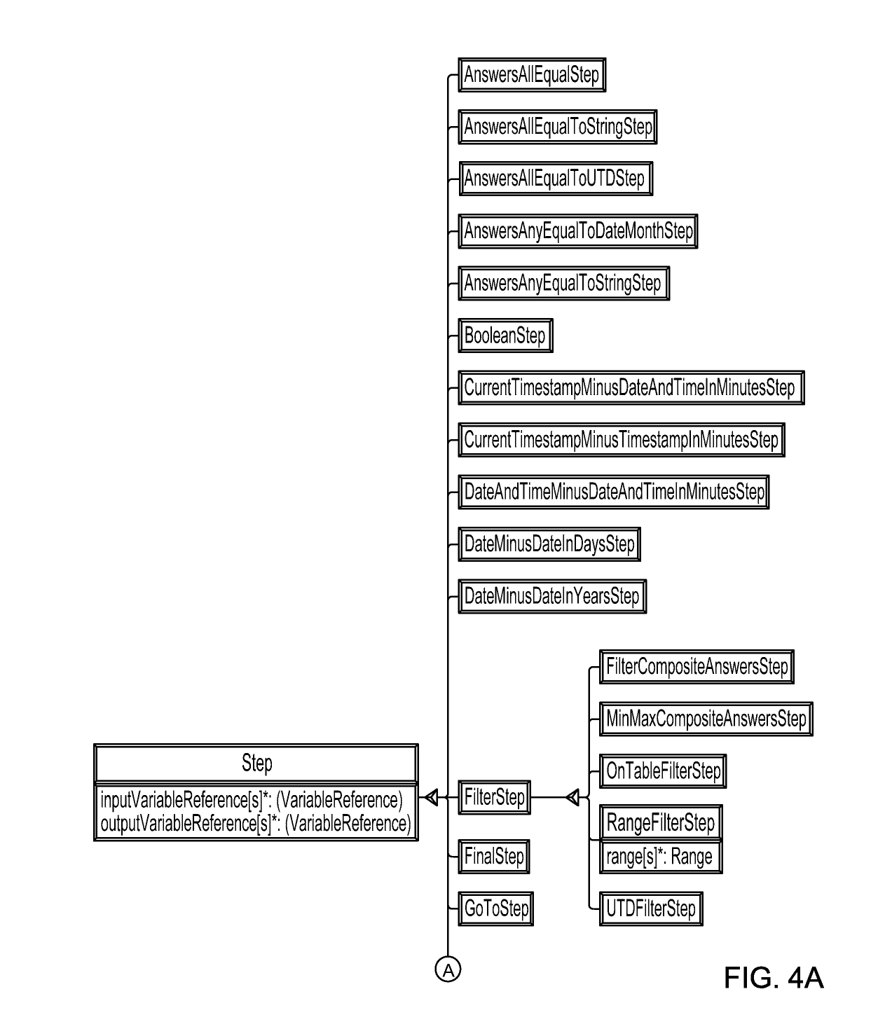

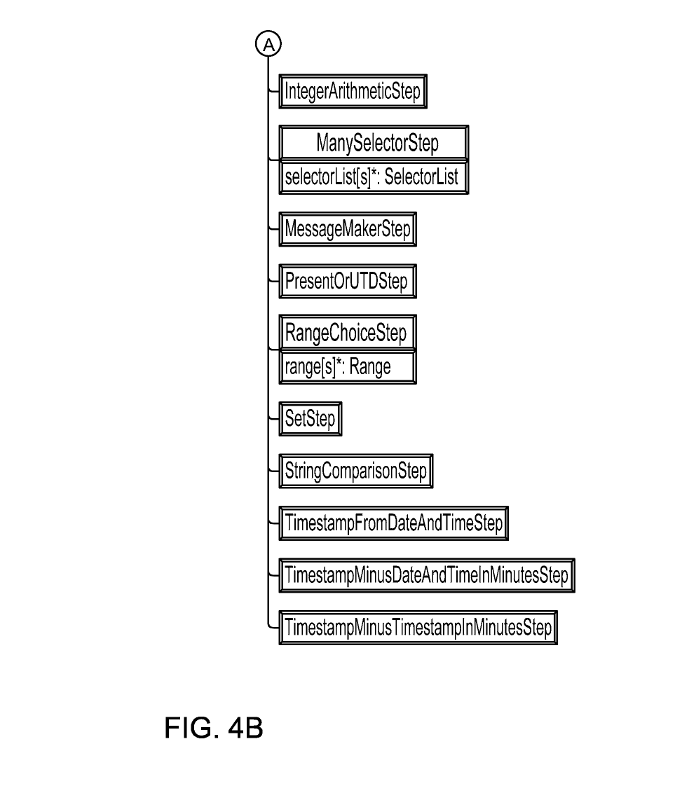

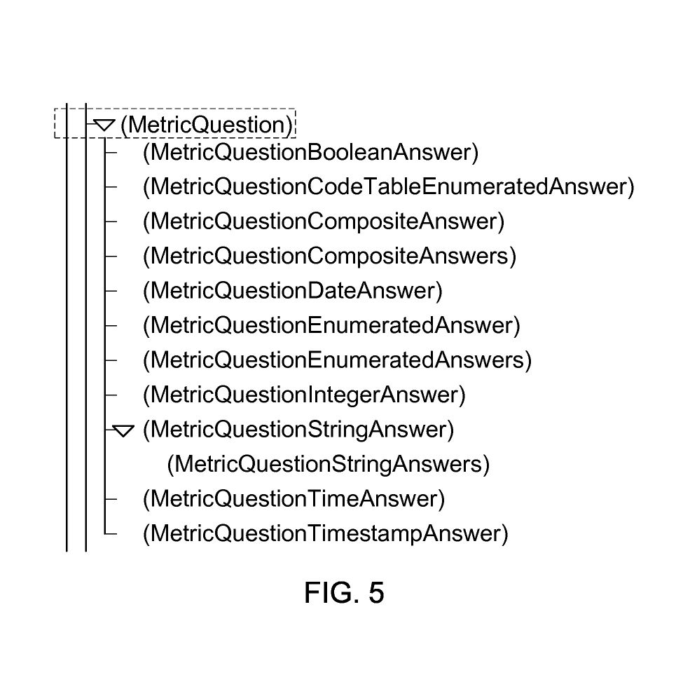

FIGS. 4A, 4B, and 5 are screen shots from an example software application that implements the failure tracking system.

FIGS. 4A and 4B illustrate subclasses of a Step class.

FIG. 5 illustrates Metric Question subclasses of a Metric Question class that define answer types for Data Elements (which are instances of Steps).

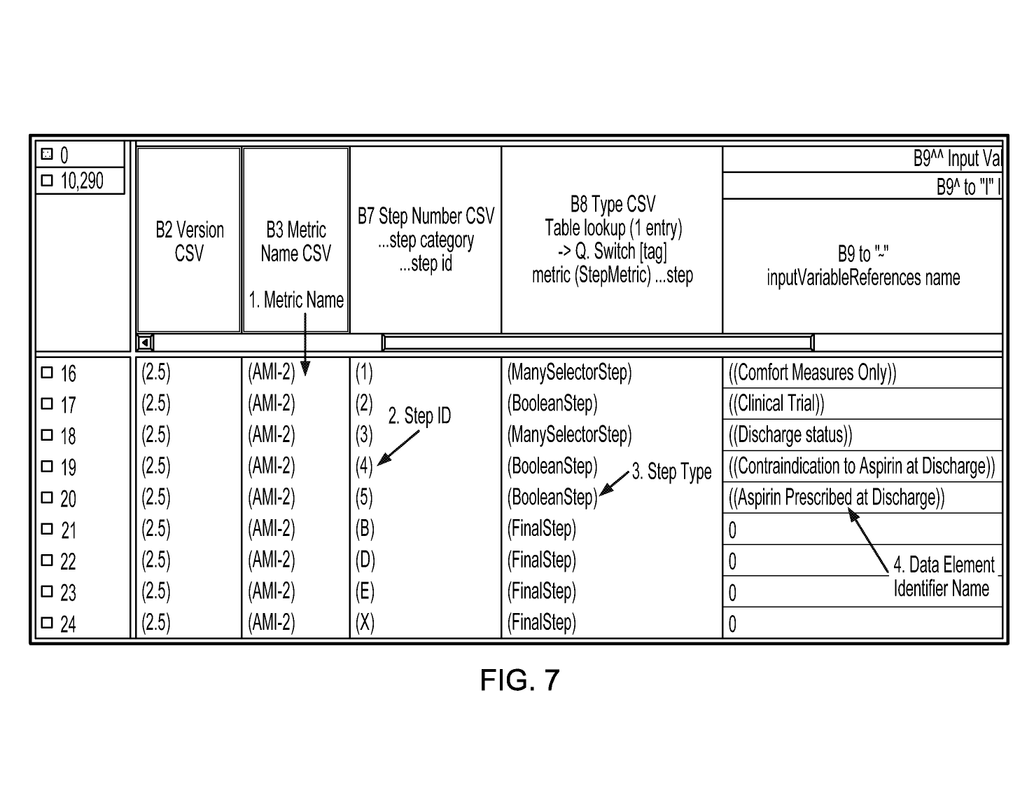

FIGS. 7, 8A, 8B, 9, and 10 show screen shots, from an example software application, of records of the data files Metric Definitions and Data Elements.

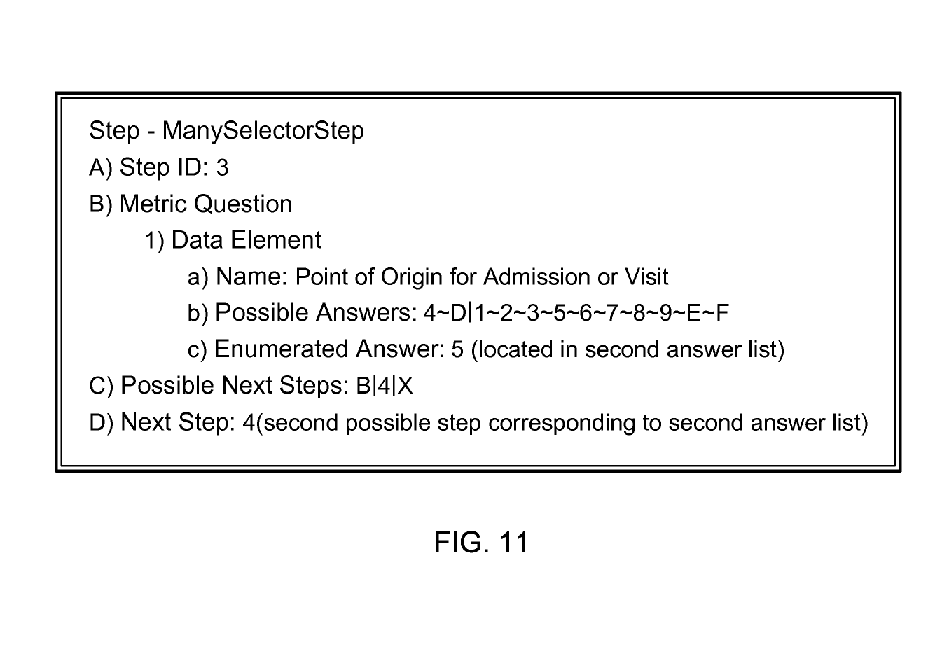

FIG. 11 shows an example of a third encapsulated Step of the ManySelectorStep subclass from the Metric Definition AMI-1 for a particular case of patient care.

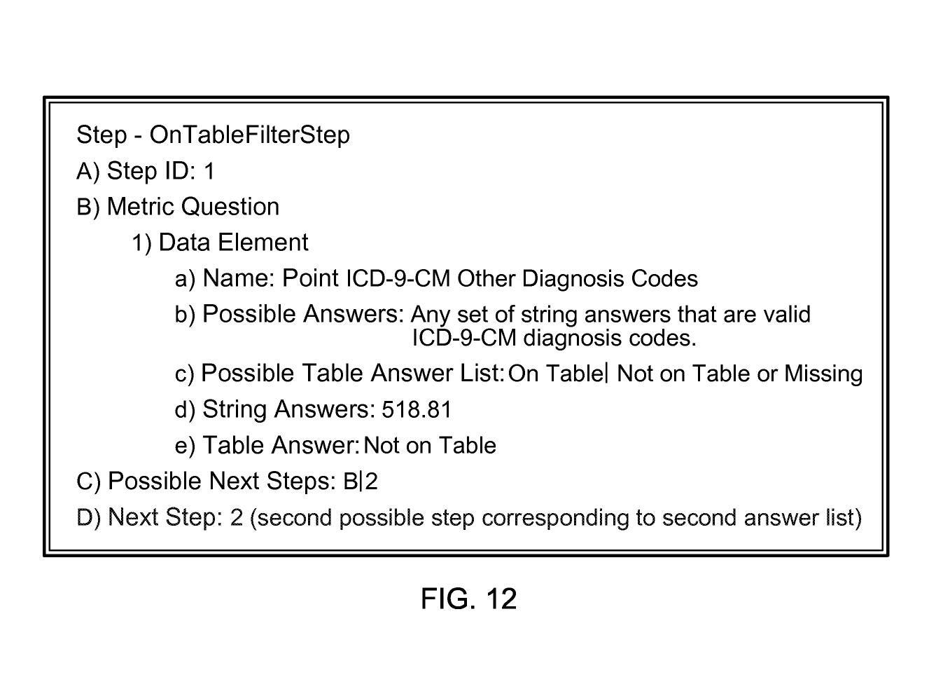

FIG. 12 shows an example of a first encapsulated Step of the OnTableFilter subclass from the Metric Definition PN-7 for a particular case of patient care.

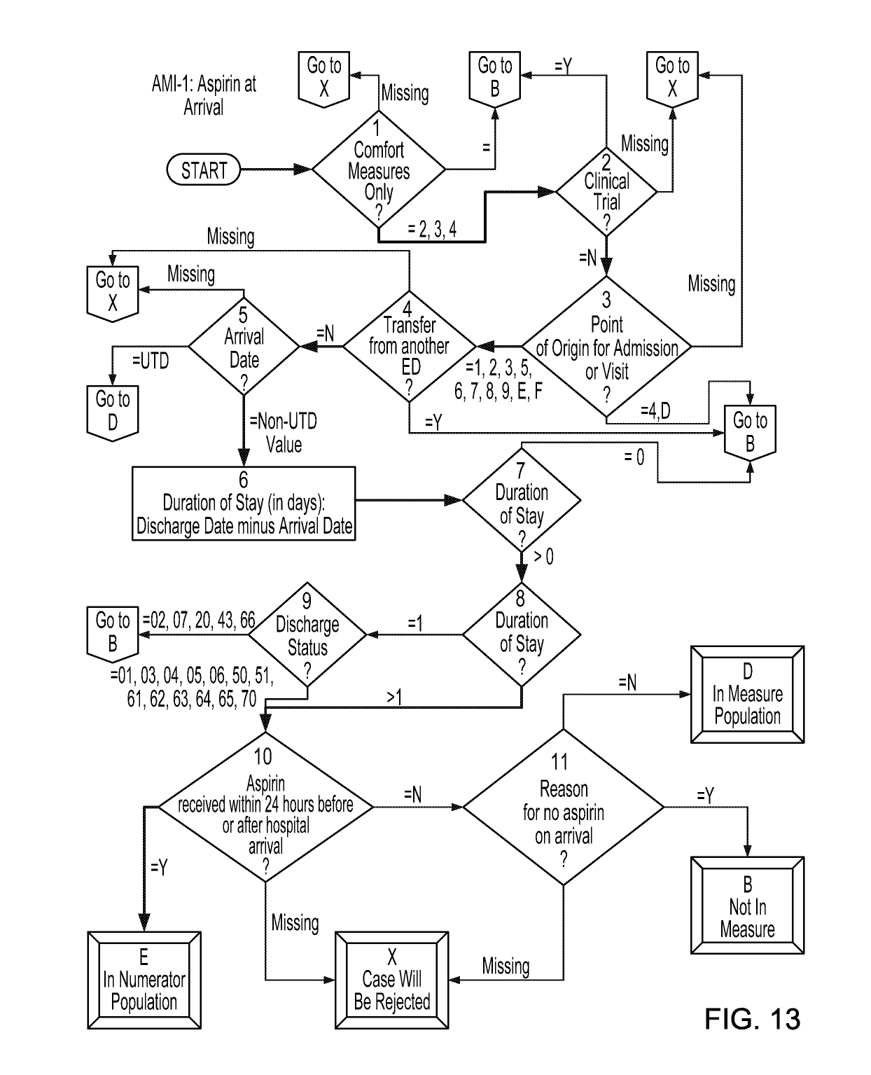

FIG. 13 is an example of a flow chart of the Algorithm AMI-1 depicting the path traversed for a possible case of patient care (sometimes called, simply, a patient case).

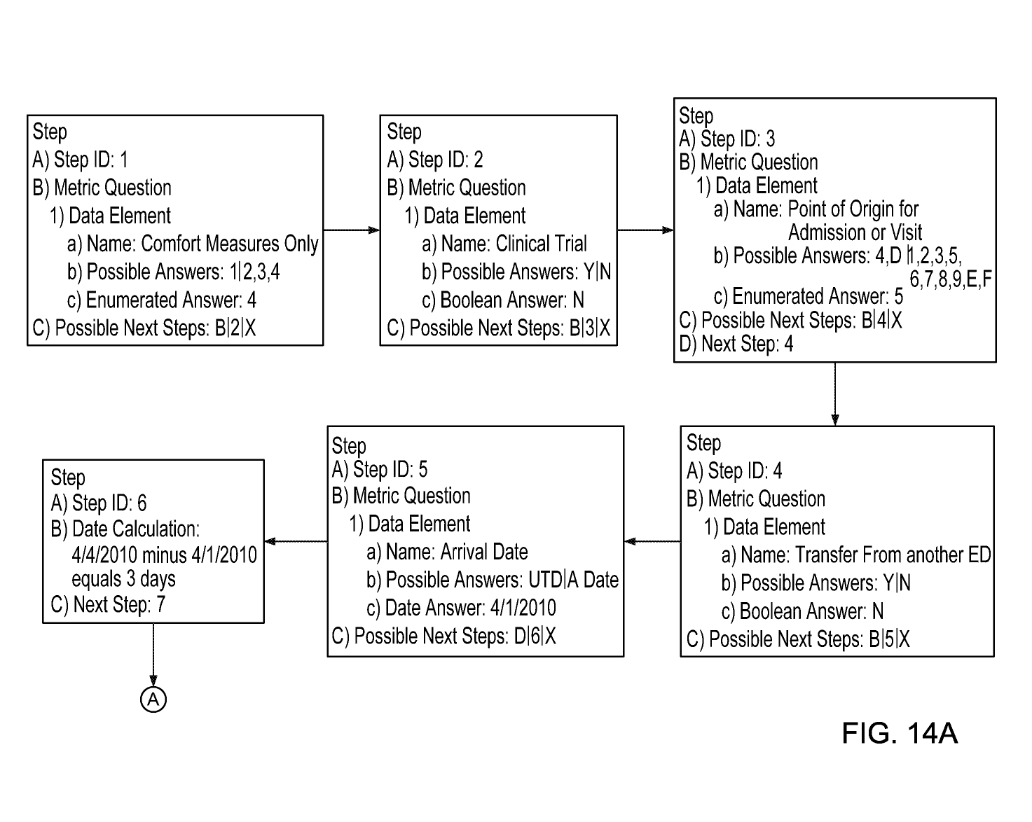

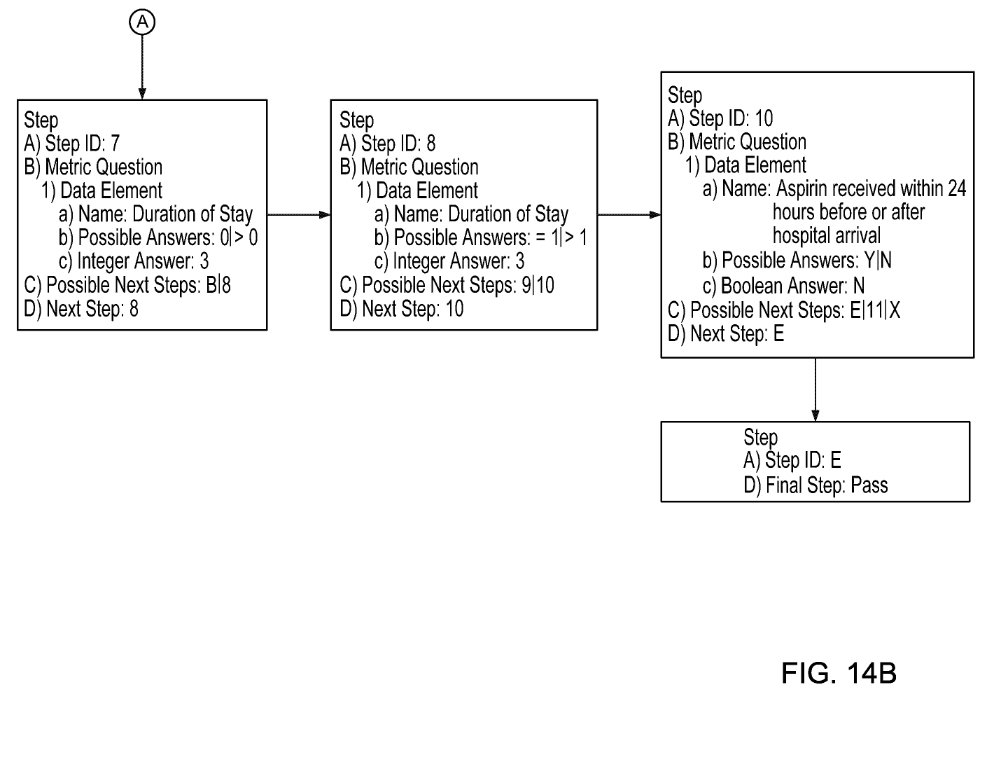

FIGS. 14A and 14B are a flowchart of how the patient case of FIG. 13 is processed using the Metric Definition AMI-1 as a collection of self-contained Steps.

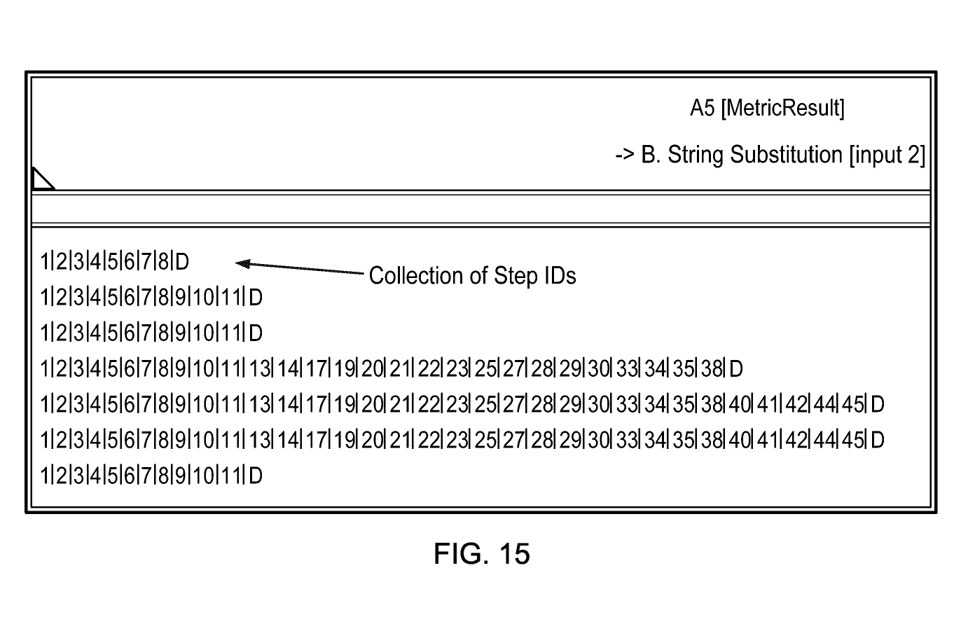

FIG. 15 is a screen shot of a report of example Reason Path strings constructed using patient care data.

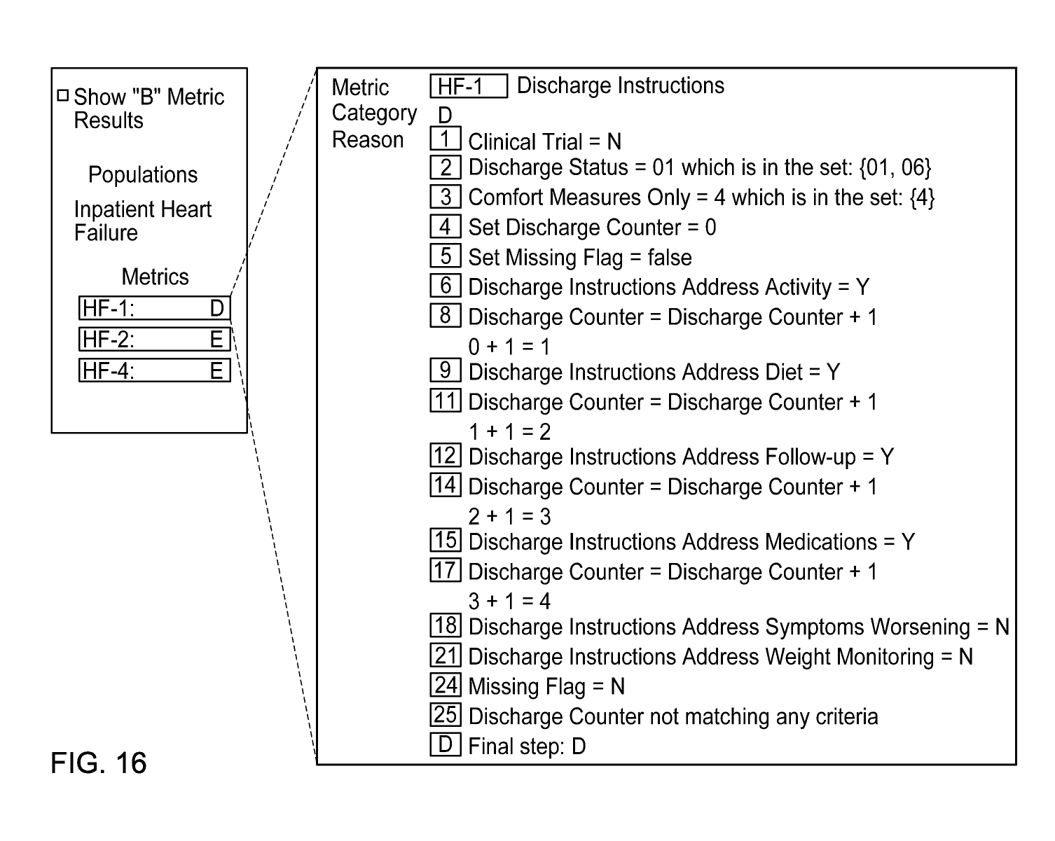

FIG. 16 represents screen shots from two areas of the failure tracking system user interface that show a Metric Definition result and a Reason Path with detailed explanation of the route taken for the case of patient care.

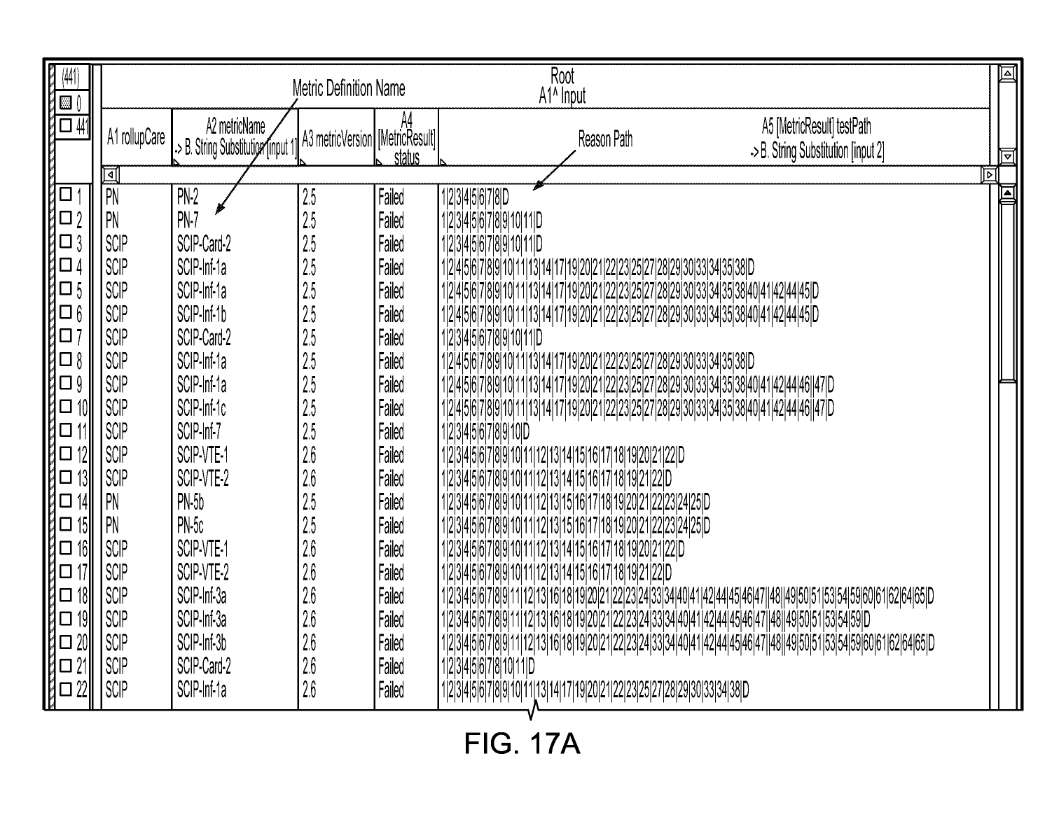

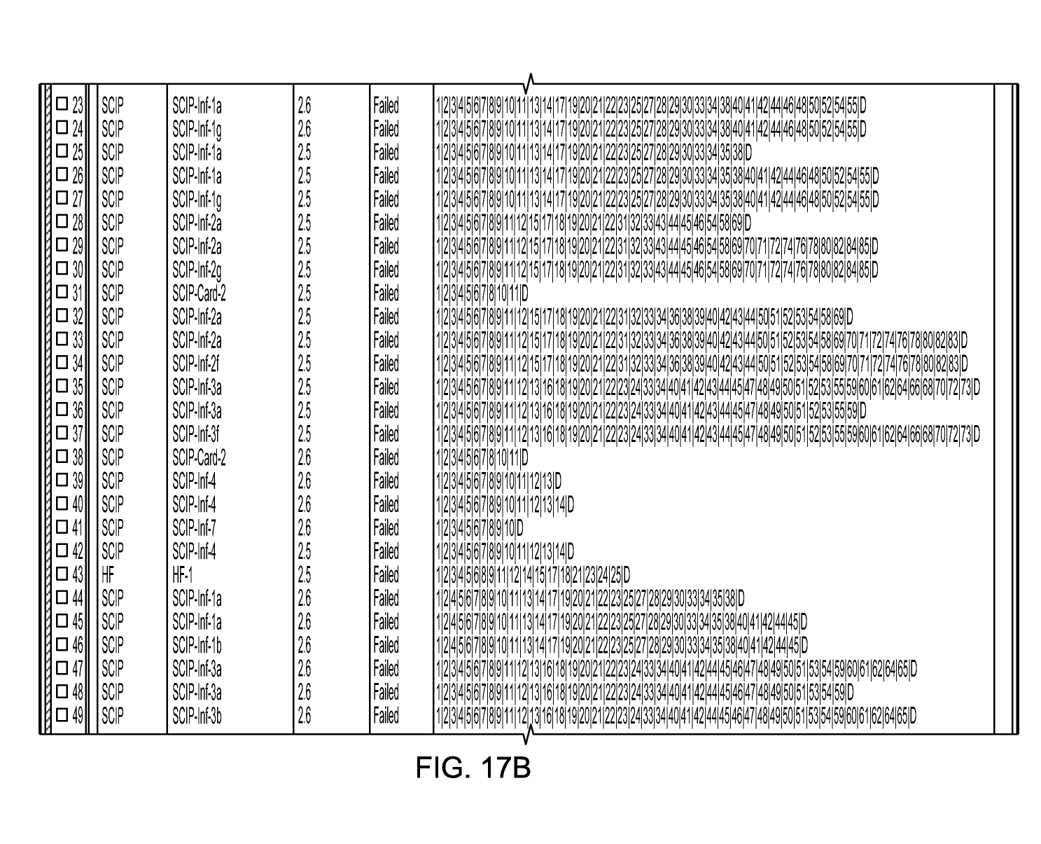

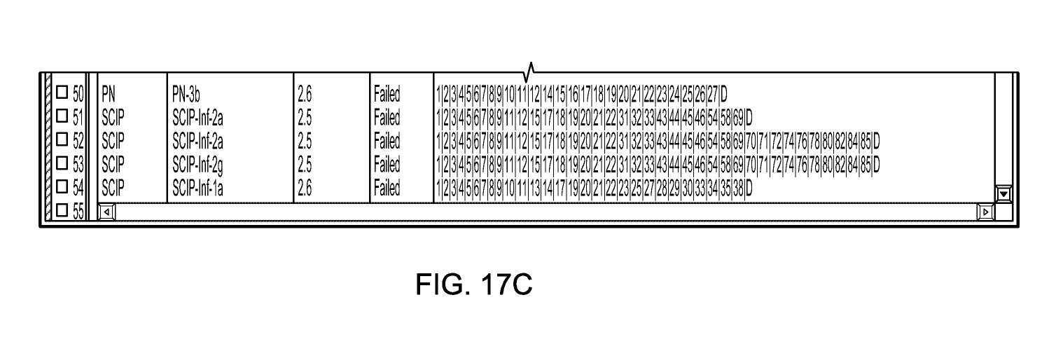

FIGS. 17A, 17B, 17C, 18, 19A, and 19B are screen shots of the software application user interface of the failure tracking system. These images follow the process of completing a Reason Path analysis for a SCIP (Surgical Care Improvement Project) measure score.

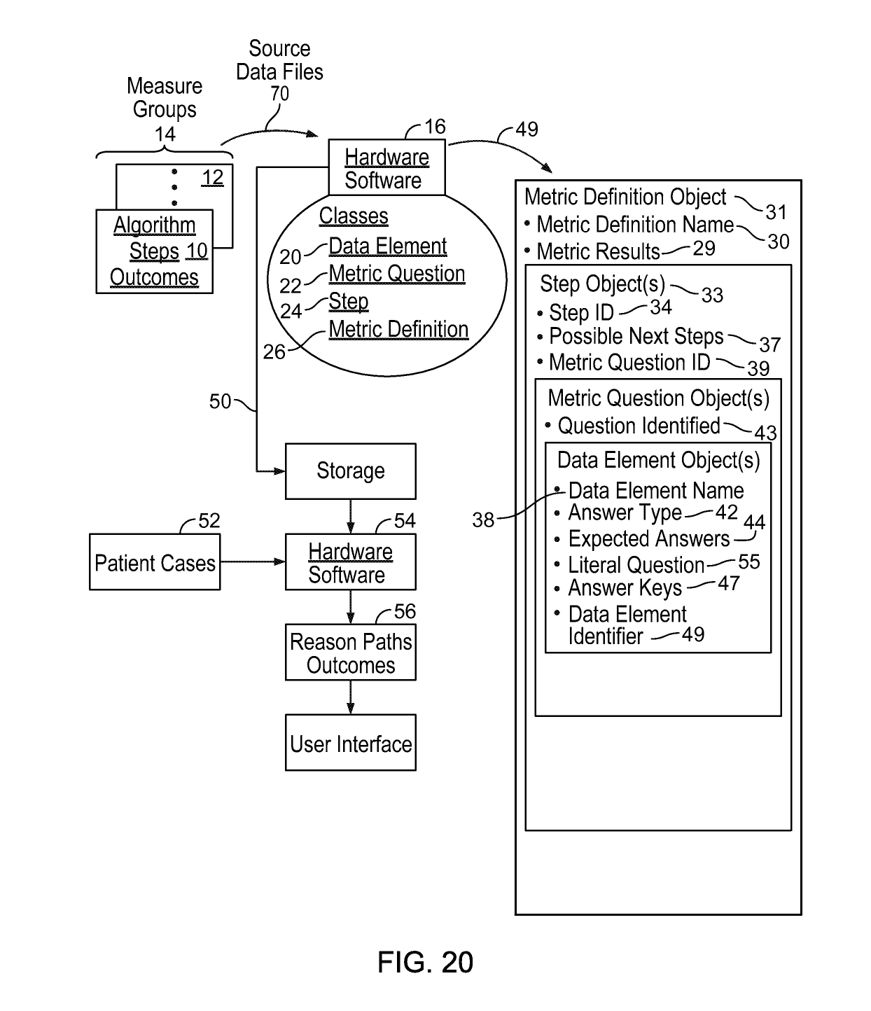

FIG. 20 is a block and flow diagram.

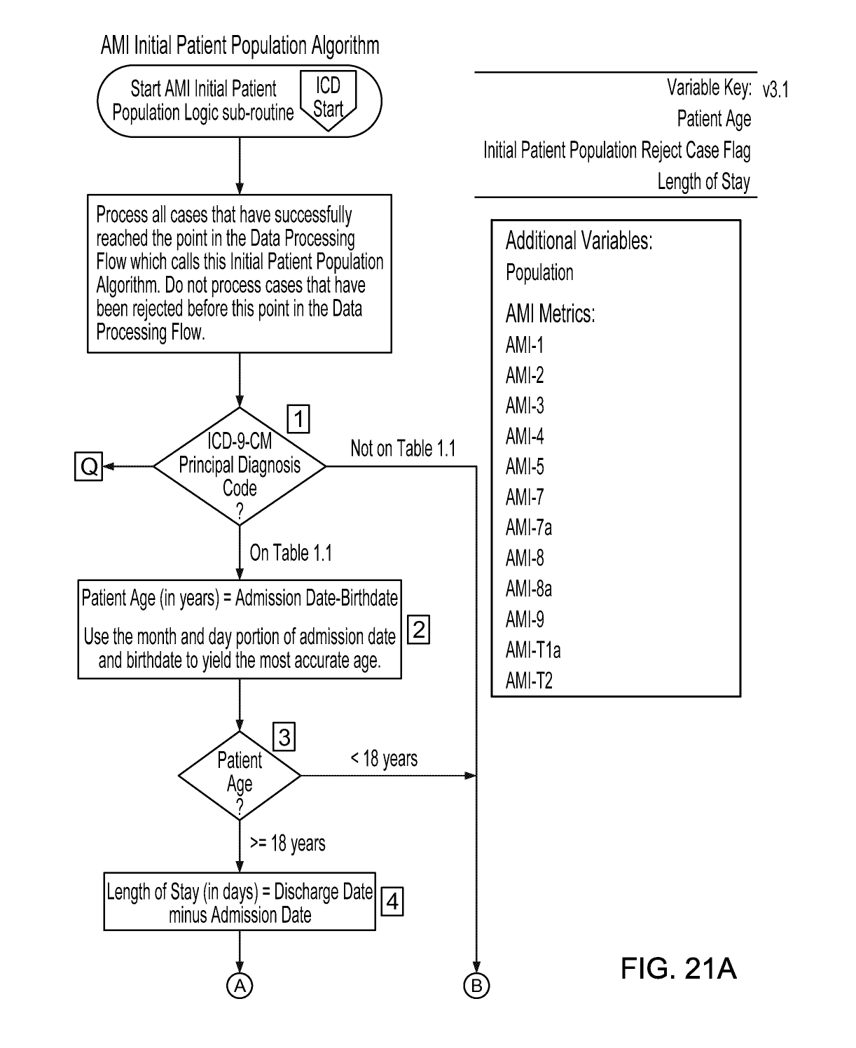

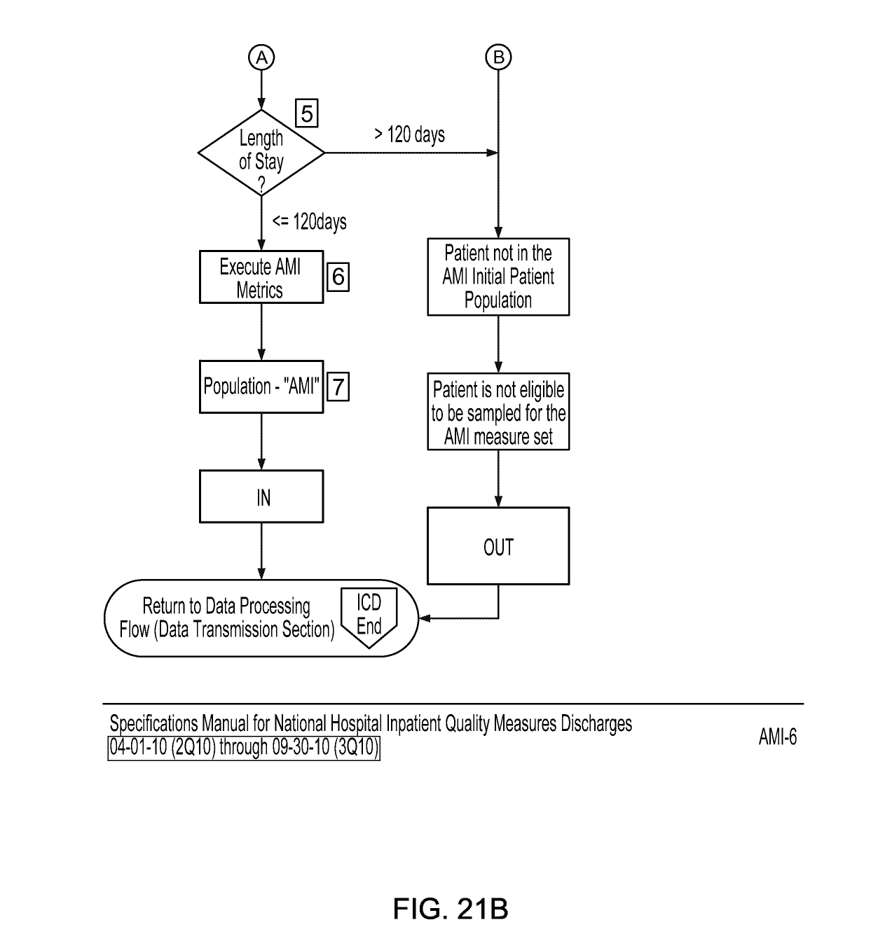

FIGS. 21A and 21B are a flow diagram for determining patient qualification for AMI measures.

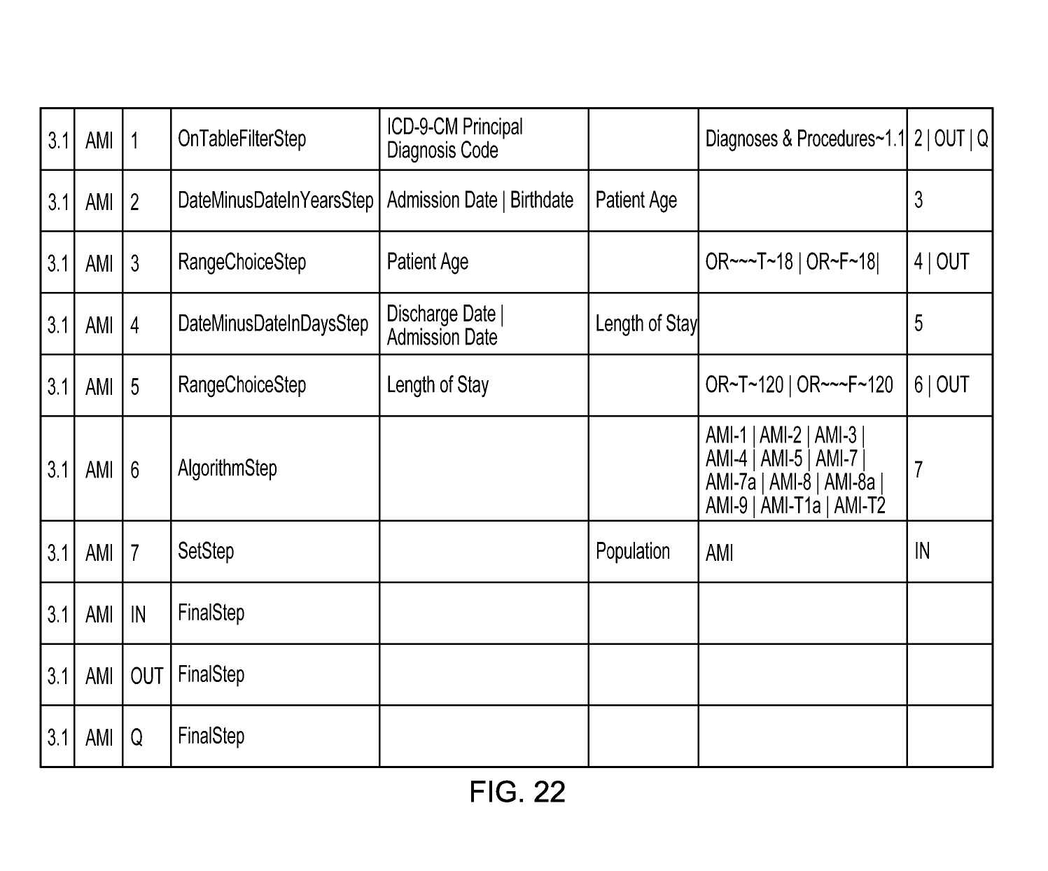

FIG. 22 is a table of steps.

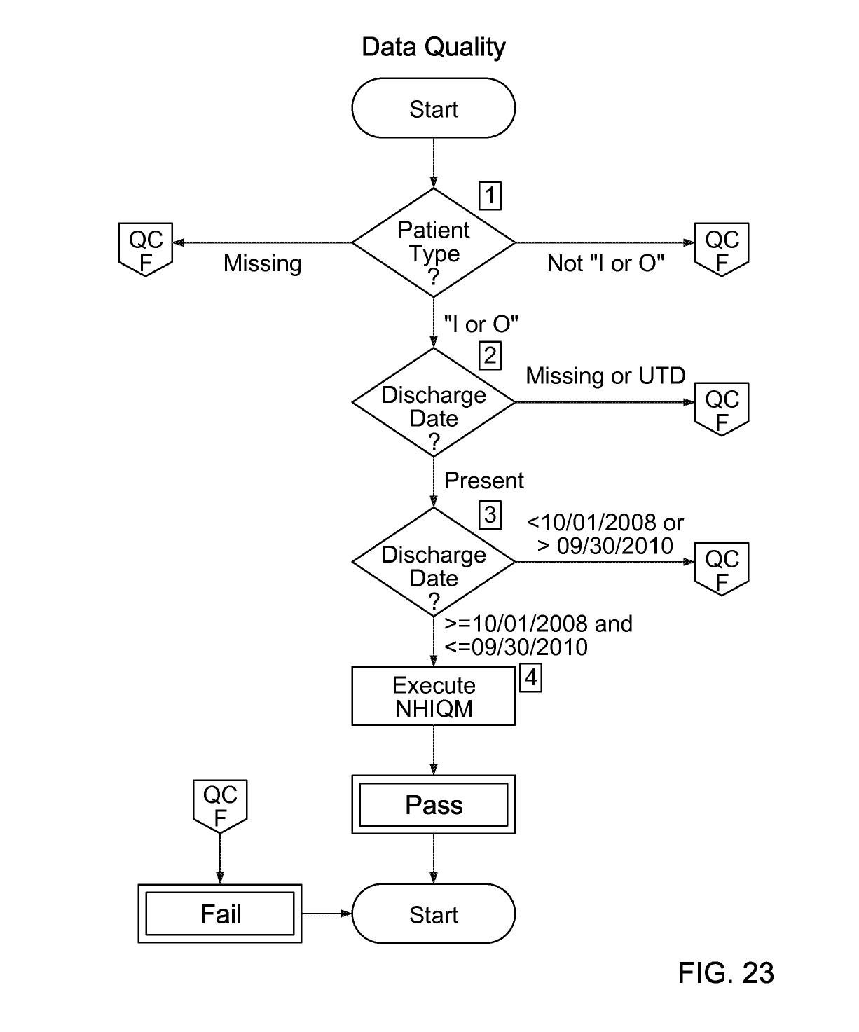

FIG. 23 is a flow chart.

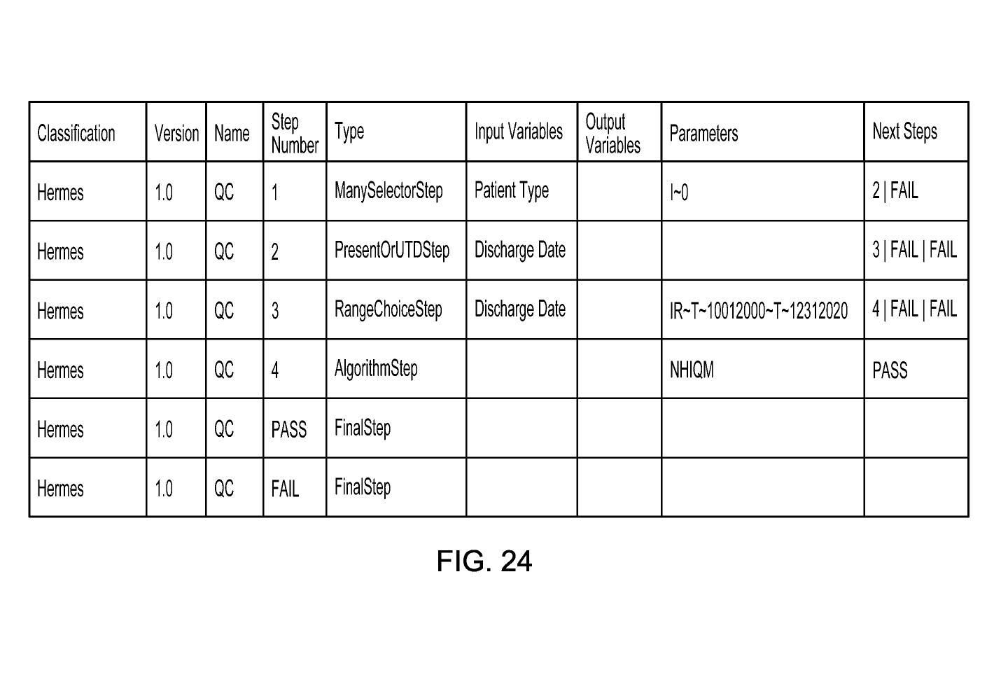

FIG. 24 is a set of records.

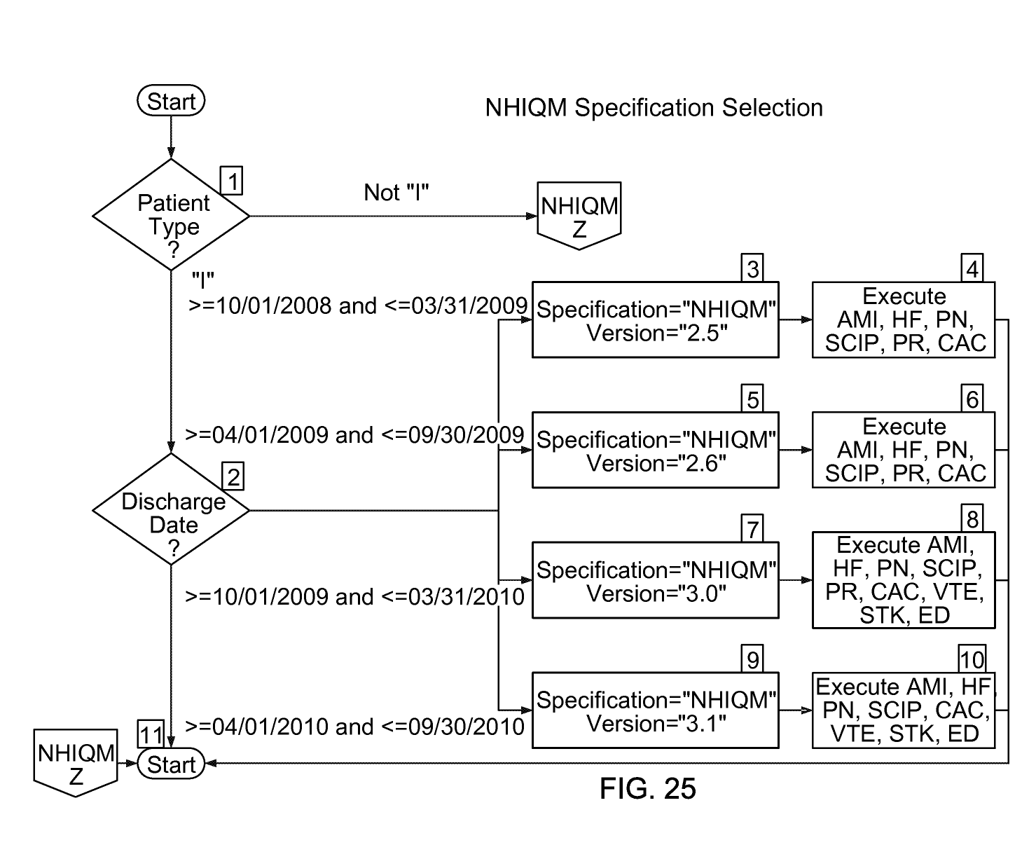

FIG. 25 is a flow chart.

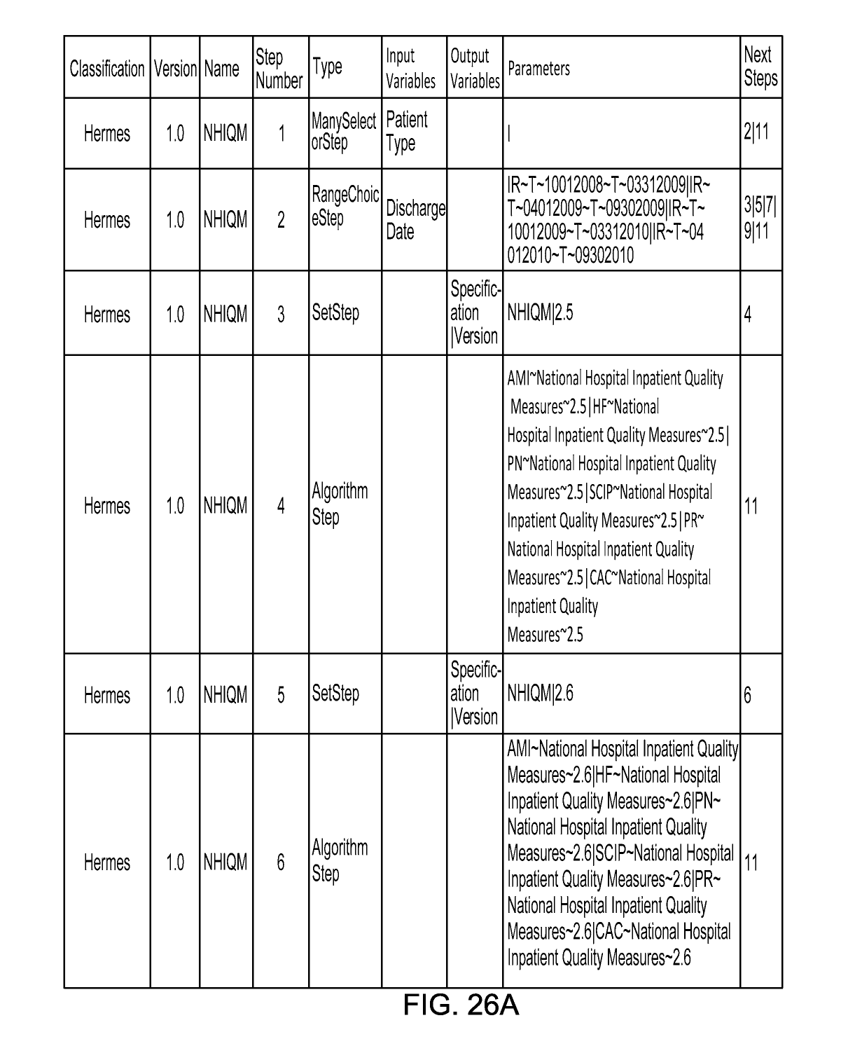

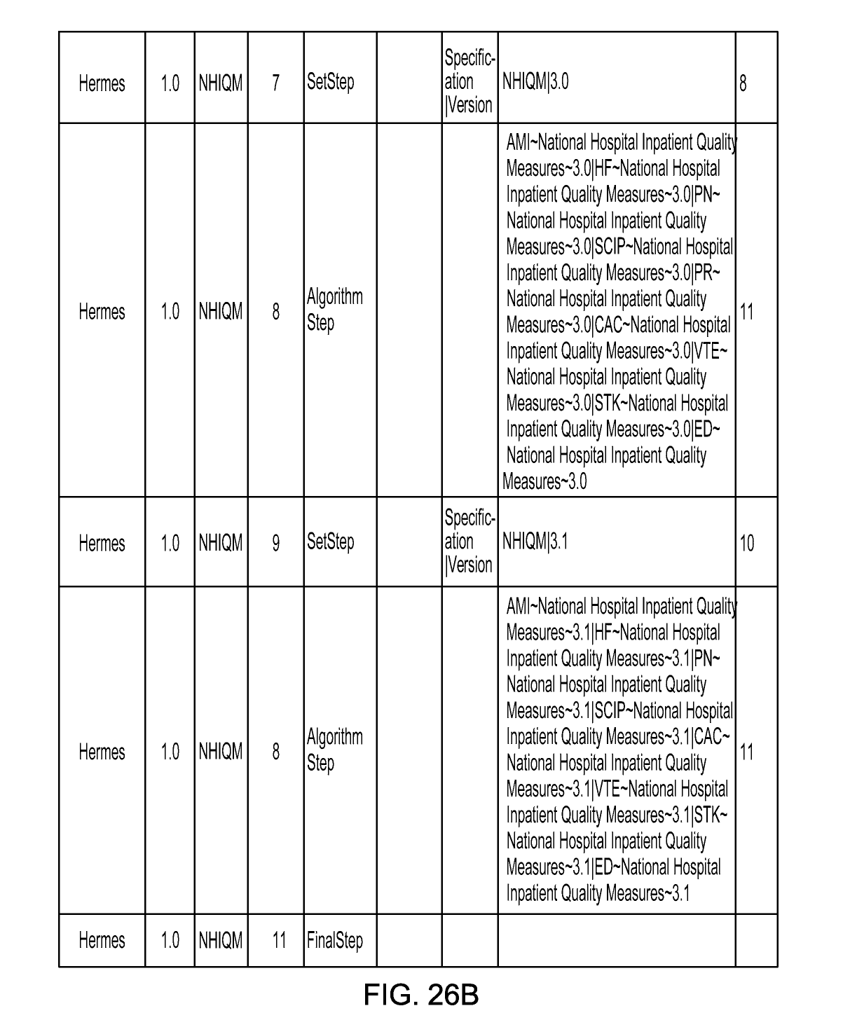

FIGS. 26A and 26B are a set of records.

MioSoft Corporation of Madison, Wis., the assignee of this patent application, has developed a generic object-oriented meta-model that enables algorithms (e.g., of standard patient treatment sequences and outcomes) to be acquired and stored in a software system. Paths taken through each of the algorithms for individual patient cases can then be tracked and stored as patient case records. Users can then analyze and see information that helps them to understand the reasons for failures in treatment.

Thus, such systems are able to compute failure paths followed in medical treatment processes that can be described by an algorithmic flowchart of steps. The system uses an object oriented meta-model that can represent such algorithms. Data is collected regarding the sequence of steps taken (path) through the algorithm of a given type of medical treatment. The sequence of steps taken shows the cause of failure in a standard medical treatment. Taking a frequency of the causes results in a better understanding of the problems that lead to substandard health care and allows health care providers to focus on the most prevalent issues first.

The model can be implemented in a software system. MioSoft has produced one such implementation, referred to as HERMES, but a very wide range of other implementations of the techniques described here is possible. In the particular example implementation discussed here, HERMES uses a software design method known as a strategy pattern. A strategy pattern is a programming structure that enables multiple algorithms to be stored in objects. At run time, for each patient case, an appropriate algorithm can be selected through which the patient case can be run and stored. Patient cases can then be analyzed to learn the causes of treatment failure for a particular class of treatment, for example, at a particular hospital.

As shown in FIG. 20, two sets of different health care treatment algorithms 10, 12 can be organized as families or groups 14 that can be encapsulated into an object. In an example implementation, the raw algorithms described in the background have been grouped into an algorithm family or group and loaded into the HERMES object-oriented meta-model, which runs on a platform of hardware and software 16.

HERMES includes four fundamental object classes—Data Element class 20, the Metric Question class 22, the Step class 24, and the Metric Definition class 26—that can be used to represent all of the main elements of a flowchart of a treatment algorithm.

FIG. 3 illustrates (for the second page of the raw algorithm Acute Myocardial Infarction-2 (AMI-2) of the Specifications Manual for National Hospital Quality Measures) how the part of a pre-defined algorithm in its raw form can be interpreted by HERMES and used in forming objects of classes that correspond to the algorithm. Numbered legends are superimposed on FIG. 3 to indicate the relationships between the parts of the raw algorithm and the data elements of the HERMES classes that are used to capture those parts, as follows (referring also to FIG. 20):

1. Metric Definition name—The raw algorithm name (in this case AMI-2) is used as the Metric Definition object name 30 of the Metric Definition object 31 of the Metric Definition class.
2. Step—Each node (also sometimes called a decision point, or a step, or a question) in the algorithm corresponds to and is the basis for forming a Step object 33 of the Step class in HERMES.
3. Step ID—A Step ID 34 is added to (that is, is not part of) the Step object that is derived from the published algorithm (we sometimes refer to a raw algorithm that has been published as a published algorithm). The Step ID is a core component in analyzing paths through Metric Definition objects because each Step object identifies Steps that follow that Step depending on the result of the decision point represented by the Step.
4. Data Element identifier—The content (e.g., the literal text) of each step in the raw algorithm is incorporated as the Data Element name (or identifier) 38 in a corresponding Data Element object 36 of the Data Element class in HERMES.
5. Metric Question type—The type of the expected answers 44 at each step of the algorithm determines a Metric Question answer type 42 of the Metric Question object 36. In this example, the predefined list of answers indicates that the Metric Question answer type 42 for this Data Element object is of type Enumerated.
6. As another example, the yes-no expected answers for another of the Data Element objects indicate a Metric Question expects a Boolean answer and is of type Boolean.
7. Metric Result—There are multiple end points for an algorithm. Each endpoint is characterized by a letter that translates into a pass/fail condition. HERMES uses the letters from the raw algorithm to represent the results as Metric Results 29 that are contained in the Metric Definition object.

The class of objects that is used to represent treatment algorithms in HERMES is the Metric Definition class. Different algorithms are represented by different instances of Metric Definition objects. Each Metric Definition object 31 contains Step objects and Data Element objects that include Data Element identifiers (that refer to specific Data Elements of the raw algorithm). Each of these objects fulfills a specific role.

A Metric Definition object is a collection of Steps for a given algorithm. Steps provide a vehicle by which the Metric Definition can be navigated with respect to actual patient cases. A Metric Definition for a given algorithm is defined by creating several Step objects and assigning to them Step IDs (so that, during the navigation, the Metric Definition knows where each step is along the algorithm, as well as where it leads) and Data Element identifiers (so that each Step knows which Data Element is to populate the Step).

A Data Element object identifies a specific question. The answer to the specific question is described by the Metric Question subclasses that define these types (e.g. time, and integer). In the meta-model, a Metric Question is a model of the Data Element object. Just as the Metric Definitions are only loaded once and then cloned to be used for specific patient care cases, there are singular creations of each Data Element (e.g., there is only one object that represents the Arrival Date), which are only loaded once and are then cloned at run time when patient care cases are processed.

HERMES creates 49 and stores 50 a single instance of a Metric Definition object for a given algorithm. At run time, each time a patient case 52 is processed in HERMES for that algorithm, a clone of the instance of the Metric Definition object is created and “run” by a hardware/software platform 54 to determine a Reason Path and Outcome 56 of the Metric Definition object that corresponds to the patient case. Each clone instance of the Metric Definition object is identified by the Metric Definition name 30, which is taken from the algorithm flowchart, as explained for FIG. 3.

In the HERMES meta-model, the generic Step class 24 represents the components that make up a Metric Definition. Step objects of the Step class are the device by which a Metric Definition object is navigated by HERMES at run time for a given patient case. Metric Questions are a class of unspecific objects that expect answers of specific types. Subclasses of the Metric Question class define the specific types of answers expected (e.g., a time answer, a Boolean answer, an enumerated answer). The answer that a Data Element object expects is classified by the Metric Question subclasses. For example, an Arrival Date (defined by a specific Data Element object) is a specific question that expects an answer of type “date” that captures the date the patient arrived. In the implementation discussed here, a Step object also includes data that knows what the next Steps 37 can be and knows its own Step identification 34.

Items 2 and 3 of FIG. 3 illustrate a Step ID 34 that has been added (for HERMES purposes) to the Step Object 33 for a corresponding step in the health care algorithm flowchart of the Specifications Manual for National Hospital Quality Measures. The Step ID is the only component that is added by HERMES to the existing components of the raw algorithm flowchart. The Step identification 34 can be any identifying string of characters, though in HERMES it is typically a numerical value, that represents the Step's sequential position in the sequence of Step objects of the Metric Definition object 31.

Not all Step objects in a Metric Definition object function in the same way. Step objects may be grouped in subclasses. FIGS. 4A and 4B illustrate Step subclasses in the health care domain for the example implementations that we are discussing here. These Step object subclasses represent different Step types that may appear in Metric Definition objects. Example Step subclasses in FIGS. 4A and 4B are: Boolean Steps (true or false), date calculation Steps, and numeric calculation Steps.

For most Step objects in a Metric Definition object, there is a question being asked. Each of the Step objects points to a Metric Question object 40 of the Metric Question class that stores the literal wording of the corresponding question 55. Each Metric Question object contains information about the specific type of answer 42 that is expected for the question contained in the object. FIG. 5 shows an example Metric Question class hierarchy.

The class structure in FIG. 5 shows Metric Question subclasses that define the Data Element object answer types 42. The answer types illustrated in this example are: Boolean Answer (a true/false or yes/no answer), String Answer (a literal answer consisting of alphanumeric characters), Enumerated Answer (an answer that comes from a finite predefined list), Integer Answer (a numeric value of integer type), Time Answer (an answer that represents a time of day), Date Answer (an answer that represents a calendar date), Timestamp Answer (an answer that contains both a date and a time), Table Answer (an answer that represents a value that is expected to appear on a predefined table), and Composite Answer (a grouping of answers that need to be associated with each other; such as a medication and the time that it was given).

Each Metric Question object 40 contains a place-holder for objects, referred to as Data Elements identifier objects 49.

A Data Element object 40 is an instance of a Metric Question object, in the form of a specific, unique Metric Question 34 and its expected answers 44. A Metric Question object defines a class of questions that expect specific types of answers, for example a Boolean type answer expects a Yes/No, true/false, or 1/0 answer. Unlike other elements of the meta-model, which all can be derived directly from the raw algorithm flowchart, the information for the Data Element object is derived outside the flowchart representation of FIG. 3. This information is defined, for example, elsewhere in the Specifications Manual for National Hospital Quality Measures.

FIGS. 6A and 6B show two Data Elements (Clinical Trial and Point of Origin for Admission or Visit) of the Specifications Manual for National Hospital Quality Measures. The following items of the corresponding HERMES Data Element object 40 are identified in FIGS. 6A and 6B:

1. Data Element objects—This is a class of Data Element objects that can be reused for multiple Metric Definition objects.
2. Data Element names 38—The name of the Data Element object is taken directly from the Specifications Manual and loaded as data directly into Data Element object in HERMES.
3. Literal Medical Question 55—This is the question that is associated with the expected answers 44 contained in the Data Element object. This question is displayed in the HERMES user interface.
4. Allowable (Expected) Answers 44 (Enumerated Type)—These are the possible answers that this Data Element object will contain. These answers dictate the type 42 of Metric Question Answer that is expected. An Enumerated type expects a specific answer from a finite predefined set of answers.
5. Allowable (Expected) Answers 44 (Boolean Type)—These are the possible answers that this Data Element object will contain. These answers dictate the type 42 of Metric Question Answer that is expected. A Boolean type expects a yes-no/true-false answer.

A Data Element object is not restricted to use for a single corresponding Metric Definition object. To the contrary, a single Data Element object can be reused for multiple Metric Definition objects. A Data Element is initially created independently of any patient case. Then when the patient case is processed, both the Metric Definition and the Data Elements are cloned for use with that patient case.

The hardware/software platform for HERMES accepts existing source data files 70 that define the algorithms for the health care domain to be used by the meta-model. The source data files contain the information that is needed by Hermes to form the Data Element objects and the Metric Definition objects for all of the algorithms in the domain. HERMES parses the data files and loads the data into Data Element objects, Metric Question objects, Step objects, and Metric Definition objects which are stored 50 for use at run time.

FIG. 7 depicts records of the parsed version of a source data file that contain data used to instantiate a Metric Definition object for, in this case, AMI-2. Each of the Steps of that Metric Definition has a corresponding Step object in the parsed file. The data of the Step objects can be presented in a user interface (as shown) with each Step object having a corresponding row on the table of FIG. 7 that displays its data.

The rows of the table show the Metric Definition Name 30 (1), the Step IDs 34 (2), the Step Types (the Metric Answer Types, that is) 42 (3), and Data Element identifier names 38 (4). Here the types of Steps and the Data Element identifiers 38 are associated with Step IDs that indicate the order of appearance in the algorithm from which the table was derived. The Data Element identifier name 38 indicates which Data Element will be called for that Step in the Metric Definition. For example, Step 5 is a Boolean step called Aspirin Prescribed at Discharge.

Because the steps of an algorithm are not unique to that algorithm, the set of Data Element objects can be smaller than the number of Steps in all of the algorithms combined. The values for these reused steps only need to be defined once in corresponding Data Element objects. Therefore, when a source data file is parsed by HERMES, only singular instances of the Data Element objects are loaded by HERMES into storage. Then, at run time, when a patient case is processed using a Metric Definition object, clones of the Data Element objects are used.

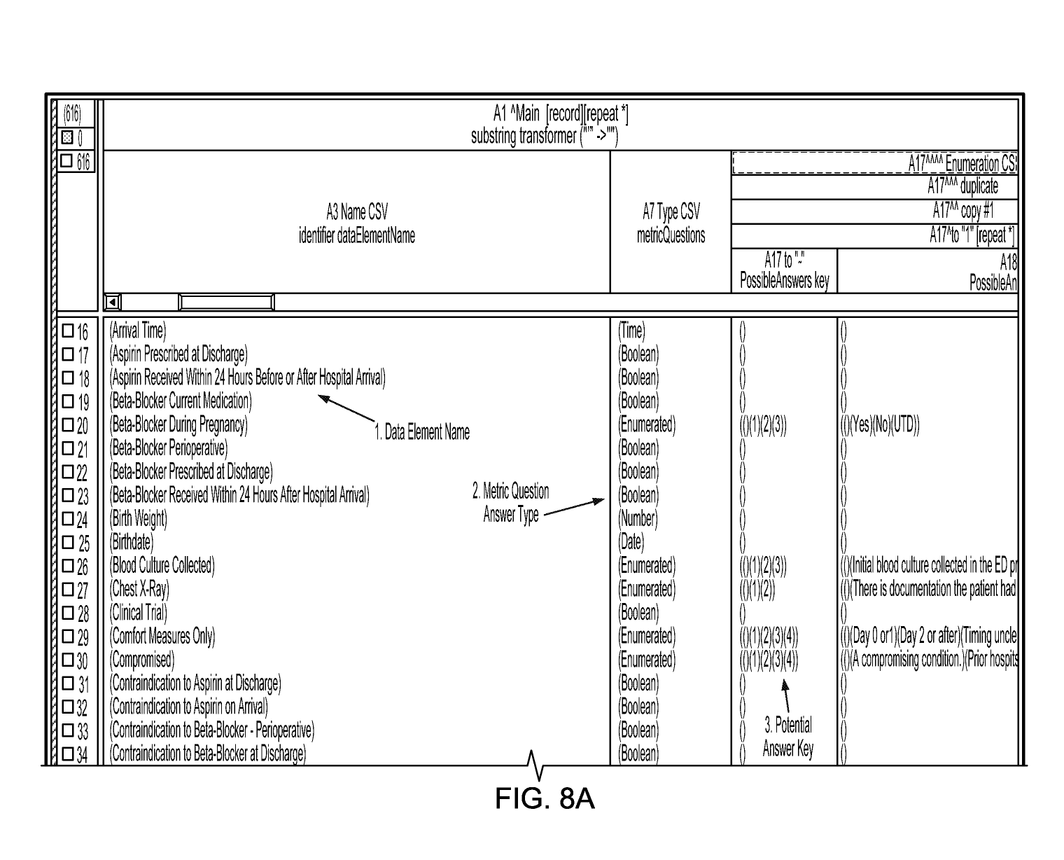

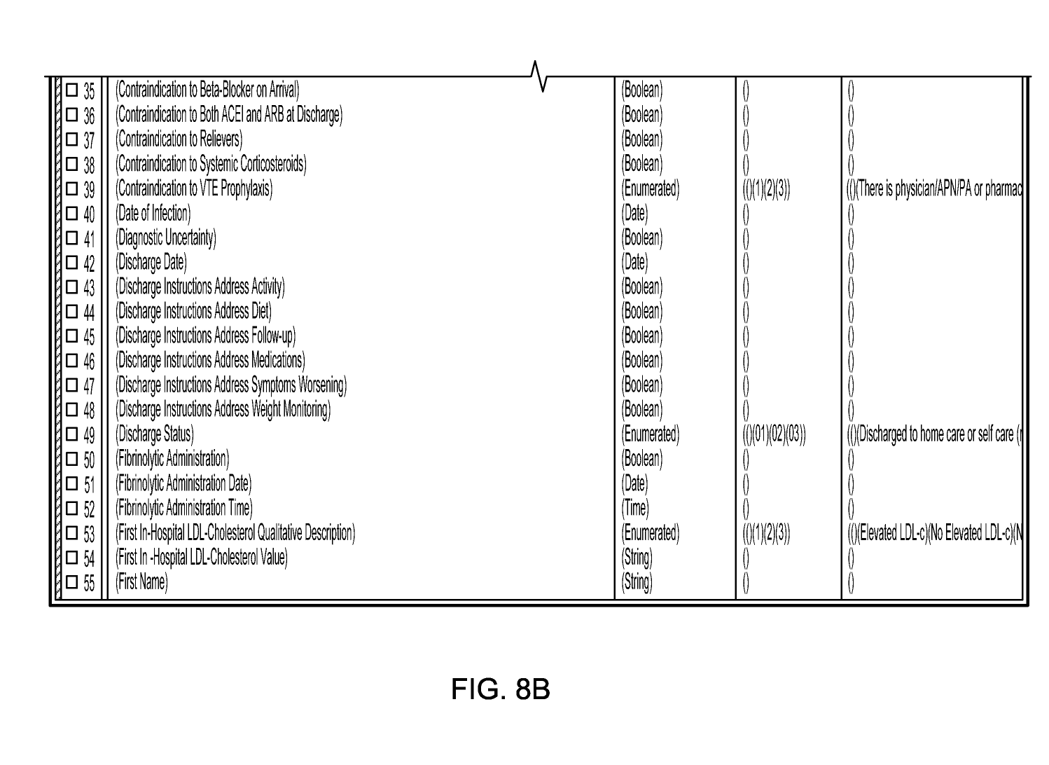

FIGS. 8A and 8B display the data corresponding to Data Element objects that were created by HERMES from a raw data file. Each row in the table corresponds to a Data Element object. The data corresponding to each possible Data Element object that will be needed at run time to process patient cases, in the relevant health care domain, appears only once in this table. For each Data Element object, there is an identifying Data Element name 38 (1), the Metric Question answer type for that Data Element 42 (2), and a list of potential answer keys (3) for the answers that the Data Element expects to be provided. The answer keys are arbitrary values each corresponding to a literal possible answer 44, which appear to the right of the answer keys in FIGS. 8A and 8B.

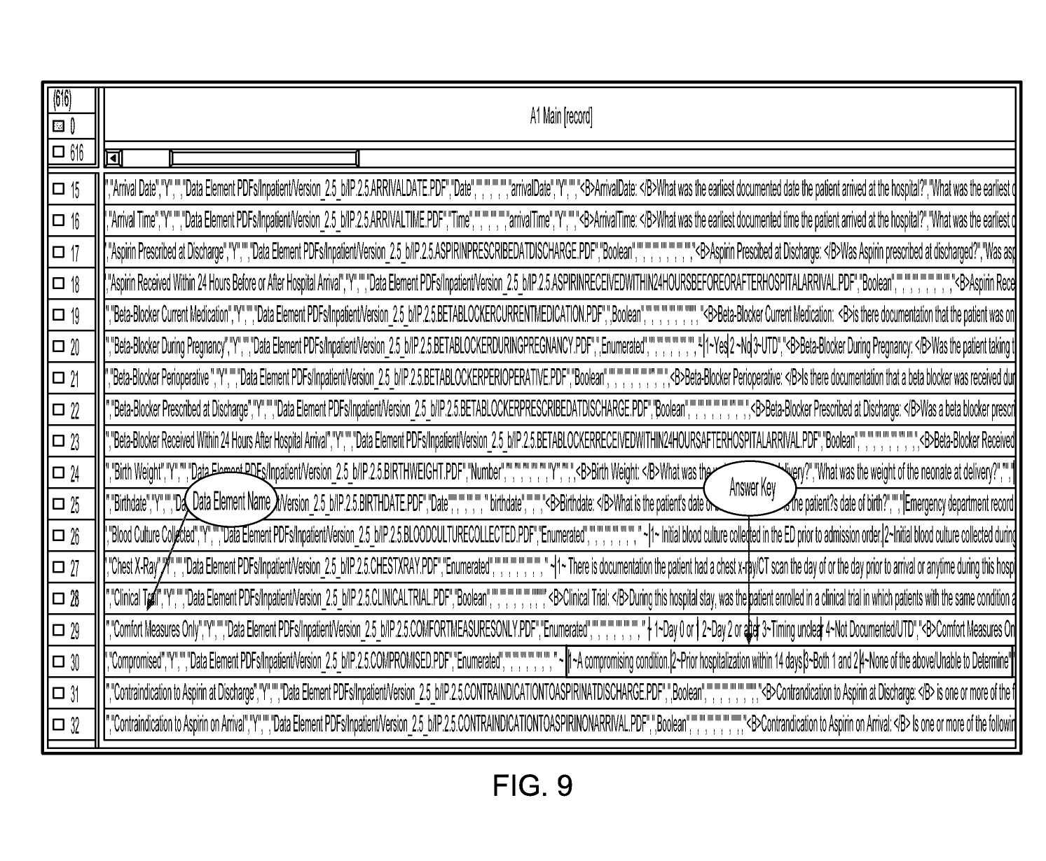

FIG. 9 shows the unparsed records of the raw data file, the parsed version of which is illustrated, after parsing, in FIGS. 8A and 8B.

As shown in FIG. 9, the raw structure of the original data file determines how HERMES interprets the data in forming the Metric Definition object and other objects. Each line of FIG. 9 represents a step of the algorithm, identified by a Data Element name (and some identifying information that follows, including the type). With respect to each step, possible next steps 37 are represented in a list identified as the Answer Key. In the answer key, successive possible answers are divided by pipes, |. Each of the answer items begins with an answer key value, followed by a tilde, ˜, and then by the next step that follows this step when that answer occurs in a given patient case.

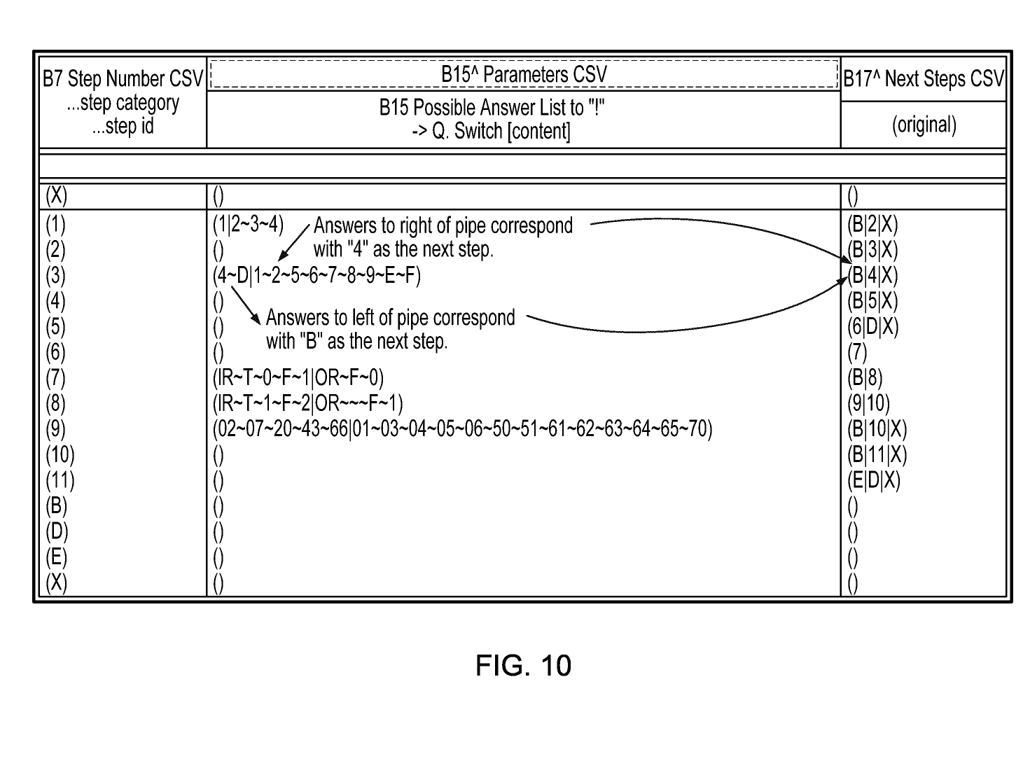

FIG. 10 shows a portion of the Metric Definition data file that has been created by HERMES and stored for a given Metric Definition object. The displayed rows define the relationship between each of a set of answer lists (one answer list per row in FIG. 10 corresponding a step of the Metric Definition object) and the corresponding possible next steps for each answer in the answer list. In this way, the rows of FIG. 10 together completely describe the structure of the algorithm from which the Metric Definition object was derived.

For example, the Data Element (corresponding to step 3 in the meta-model of our example), Point of Origin for Admission or Visit, in the algorithm AMI-1, has the following list of potential answers to choose from: 4≈D|1≈2≈3≈5≈6≈7≈8≈9≈E≈F|none. This list appears in the row identified as step 3 of FIG. 10.

The pipes indicate that there are three potential answer sub-lists from which an individual answer can be chosen for this Data Element. The lists are 4≈D; 1≈2≈3≈5≈6≈7≈8≈9≈E≈F; and a missing answer.

These three answer sub-lists correspond respectively to the three potential next Steps to be taken in the Metric Definition. Using the pipe delimiter, the next Steps are represented as B|4|X as shown in the column to the right of the answer sublists in record 3 of FIG. 10.

When paired with the potential answer lists 4≈D|1≈2≈3≈5≈6≈7≈8≈9≈E≈F|none, the pipes separating the next Steps indicate:

B—the next Step is Step B (not in measure population) if the answer to the current Step is either 4 or D (this is the first answer sub-list)
4—the next Step is Step 4 if the answer to the current Step is one of 1≈2≈3≈5≈6≈7≈8≈9≈E≈F (second answer sub-list)
X—the next Step is Step X if the answer is missing (third answer sub-list)

Each Step of FIG. 10 is represented in HERMES as a fully encapsulated Step object. The Step object identifies a set of information that allows HERMES to navigate the portion of the Metric Definition represented by that Step.

At run time, when patient cases are to be processed, correseponding instances of Step objects are formed.

FIG. 11 shows an example of a representation of such an instance of a HERMES Step object that is based on the Metric Defintion AMI-1 and whose subclass is a ManySelectorStep. FIG. 11 represents the encapsulated contents of a Step object representing a clone of the Data Element instance of Point of Origin for Admission or Visit for a case of patient care. The Step ID is 3 because it is the third step in this Metric Definition object.

This particular ManySelectorStep object for this case of patient care has a Metric Question that expects an answer of an Enumerated type. The cloned Data Element instance for this Step has a name Point of Origin for Admission or Visit. The possible enumerated answers for this Step indicate how a patient came to be admitted to the hospital (for example, code 4 indicates the patient was transferred from a Hospice facility). The actual answer for this particular patient case at this Step is 5 (transfer from skilled nursing facility). As answer 5 is located in the second answer list, the next Step should be the second step listed in the Possible Next Step list (in this case, 4). Thus the result of this step for this patient case is to move to Step 4 of this Data Element instance of this Metric Definition object.

As mentioned earlier, not all Step subclasses function in the same manner. The example in FIG. 11 represents a Step of the subclass, ManySelectorStep. This step checks to see if the answer contained in the Data Element is in the predefined answer list.

Another example of a Step subclass, shown in FIG. 12, is the OnTableFilterStep subclass. As background, in the health care domain, in some cases data pertinent to making specific care decisions, such as medications and identification codes, are contained in tables. These tables are loaded into HERMES as data files. In some Metric Definition objects, at run time, values from a patient care case must be cross-references to the values on these tables.

In FIG. 12, the OnTableFilterStep subclass checks to see if answer values stored in a Data Element object appear on a predefined table. The presence of a value on a table determines how HERMES proceeds through the Metric Definition object. The example of FIG. 12 comes from the raw Metric Definition, Pneumonia-7. The first Step asks if the ICD-9-CM Other Diagnosis Codes are on the IDC-9 table 3.4. In this particular patient case, the code listed, 518.84, is not located on table 3.4. The step therefore chooses the result that the code is not on the table. As this is the second option in the Possible Table Answer List, the step chooses the second option in the Possible Next Step list, Step 2. HERMES utilizes the above convention for traversing a Metric Definition object for each patient case.

FIG. 12 is a representation of a patient case that is being processed through the algorithm flowchart, AMI-1 using the objects that HERMES has created and stored. FIG. 13 shows the corresponding path through the algorithm as it would be “walked through” on paper. The entire algorithm is displayed with bold red arrows traversing the path of the patient case.

As each Step in a Metric Definition object is fully encapsulated, the patient case portrayed in FIG. 13 will be represented by a collection of Step objects in HERMES. FIGS. 14A and 14B illustrate a set of fully encapsulated Step objects and demonstrates HERMES' processing of the patient case of FIG. 13. Depending on the answers to the Metric Questions that are represented by the data of the patient case, HERMES will proceed through a subset of the Metric Definition Steps. FIGS. 14A and 14B show the collection of the subset of Steps traversed in FIG. 13. Each Step contains information contained in the Step's ID, the Metric Question being asked, the Data Element, the next Steps, and the actual answer relative to the specific patient case.

HERMES traverses the Metric Definition object for each possible patient case, collecting the Step IDs that it passes through and stores them in a string representing that case. HERMES inserts pipes between each recorded Step and the next step in the string. The patient case example in FIGS. 13, 14A and 14B produce the string 1|2|3|4|5|6|7|8|10|E.

FIG. 15 depicts a portion of records in HERMES that illustrate some of these strings for different possible patient cases for a given Metric Definition object. The use of encapsulated Step approach enables a key feature in the user interface of HERMES: users can view a summary of a Reason Path with explanations for each patient case. By Reason Path we mean the sequence of Steps that were traversed through the algorithm and that led to the outcome for the patient case. The summary is created using information encapsulated in each Step object that is processed in the path. From the Metric Definition object, the collection of Step IDs of the Reason Path, the Metric Question answers, and the Data Element names can be combined to provide a detailed summary of the path and outcome of a Metric Definition object for a specific patient case.

FIG. 16 shows the HERMES user interface illustrating this feature. A Heart Failure Metric Definition result (in this case, Inpatient Heart Failure of kind HF-1) is shown on the left and the description of the path is shown on the right. A user interacting with (or invoking) each of the alternative Metric Results on the left (HF-1, HF-2, HF-4) causes the display on the right hand side of the user interface of the Reason Path summary. The Reason Path summary shows each Step ID from the Reason Path with a brief explanation of what occurred at each Step for a particular Metric Definition as applied to a specific patient case.

Processing raw health care algorithms to produce a corresponding set of encapsulated interchangeable Step objects, that can be combined to represent every possible path through a Metric Definition object, and thus every possible Reason Path and result, enables a flexible system for quickly analyzing any patient case and its outcome. The system provides a standardized data structure that can be used to uniformly capture algorithms across any health care domain. By assigning Step IDs to each Step object in the Metric Definition object, it is possible to record the outcome of the health care algorithm and the path taken to that result. That recorded path can be used to better understand the reason for algorithm failures.

In HERMES, the path traversed through an algorithm is summarized by a series of integer values, each representing a specific Step object in the Metric Definition object. The result of the Metric Definition (represented by a letter) is appended to the string of Step ID's to give the complete path traversed and the result. These output strings from HERMES, illustrated in FIG. 15, are referred to as Reason Paths. To illustrate, one possible Reason Path of a patient case for the Metric Definition for AMI-2 (Acute Myocardial Infarction) from the Specifications Manual for National Hospital Quality Measures can be summarized as “1|2|3|4|5|D”. In this patient case, five specific steps before the failing result at Step 5. The Reason Path indicates the complete algorithmic path that caused of the failed outcome of this patient case by listing the sequence of Steps that played a role in the determination of the grade received for the care provided.

Of course, for each Metric Definition object there are a finite number of Reason Path permutations. Each permutation represents a different type of patient case path leading to an outcome for the Metric Definition object. The outcome of every patient care case for a particular Metric Definition can be expressed, in advance, by one or another of these permutations.

For example, from the AMI-2 example, the string “1|2|3|4|5|D” represents not only an instance of a patient case, but also a class of patient cases for AMI-2. The use of classes of Reason Paths enables grouping multiple similar patient cases based upon the Steps traversed for those cases in the Metric Definition object. These groupings allow analysis of the causes for a hospital's overall patient treatment score. Using software implementing methods described in U.S. Pat. No. 7,512,610, which is incorporated here by reference in its entirety, a frequency count of reason paths can be performed on a set of actual patient care cases. This frequency provides the data required for what we call a causal analysis for a hospital for that Metric Definition.

The steps for completing a hospital causal analysis and revealing the classes of failed cases that led to for a causal analysis score are as follows:

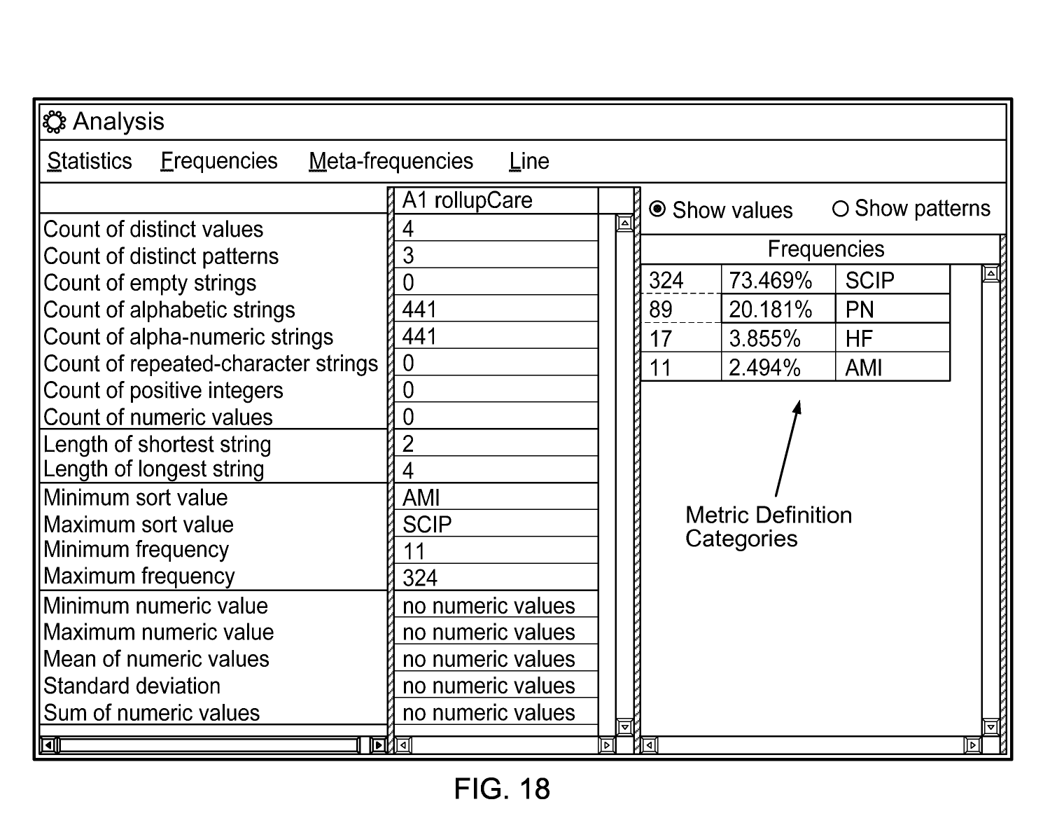

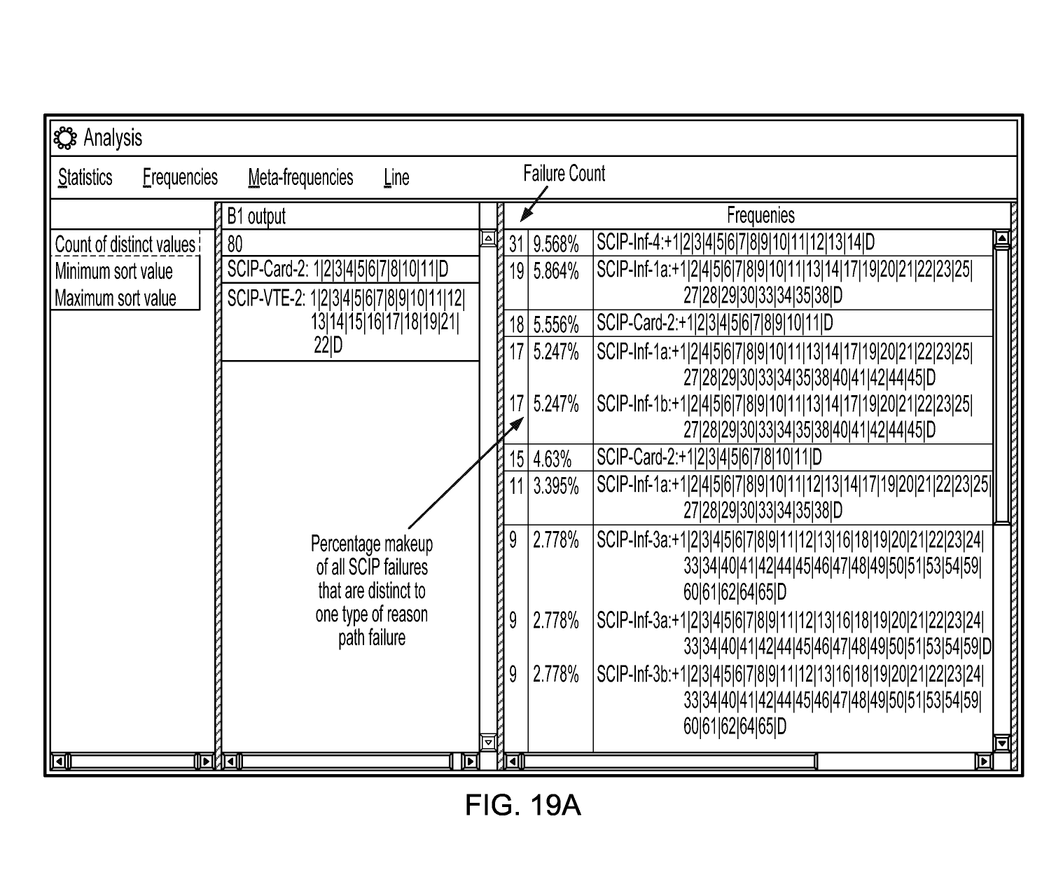

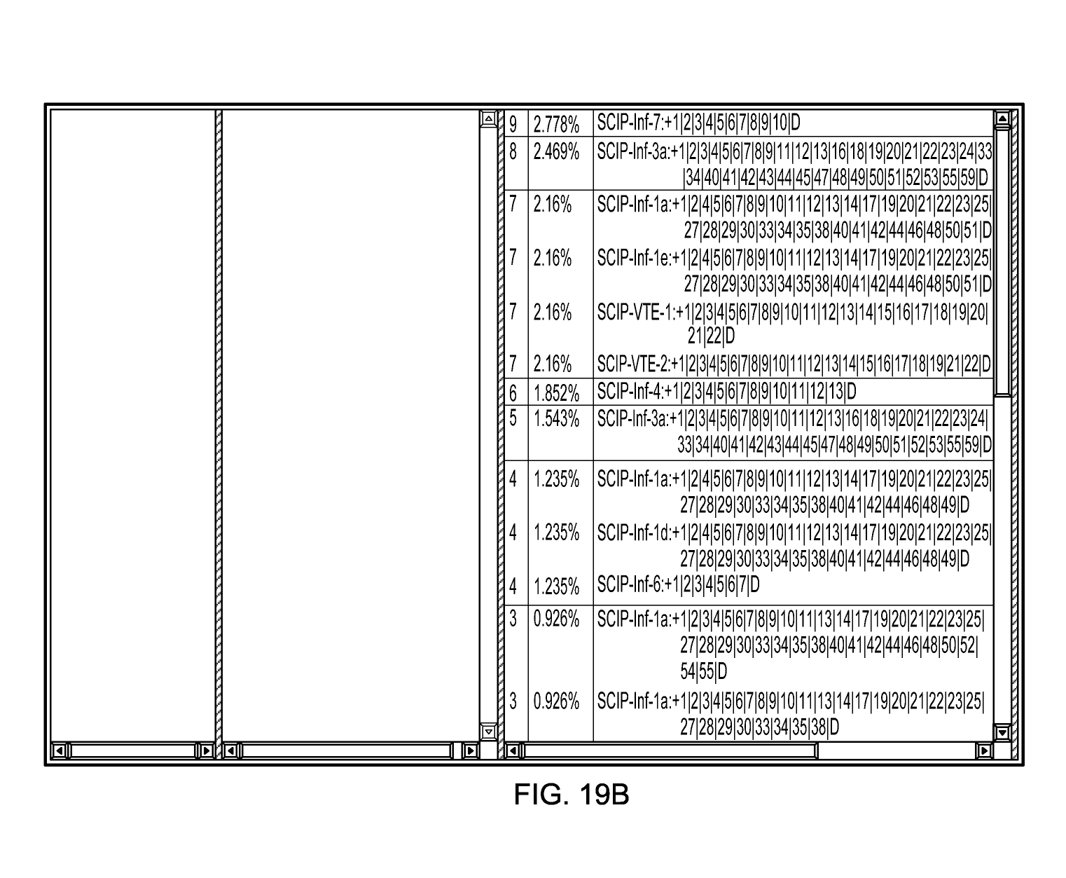

1. Obtain a report listing all Reason Paths over a population of patient cases, as illustrated in FIGS. 17A, 17B, and 17C. For this population of patient cases, each line represents a unique Reason Path (relative to the others shown) and a result. Each real patient case is represented by one of the rows of the table.
2. Aggregate the Reason Paths into measure groups as seen in FIG. 18. For example, all Reason Paths through the Metric Definition Objects that relate to SCIP can be aggregated, based on the prefix values in the Metric Definition names as shown in FIGS. 17A, 17B and 17C. Note that the table of FIGS. 17A, 17B and 17C includes Reason Paths for many Metric Definition Objects and therefore many raw algorithms.
3. Perform a frequency analysis on the Reason Paths for a specific measure as shown in FIGS. 19A and 19B. In the this SCIP example the Reason Path of SCIP-Inf-4, 1|2|3|4|5|6|7|8|9|10|11|12|13|14|D, comprised 9.568% of all the failures in the root cause analysis in this sample of patient cases. Then it can be reasoned that a potential significant process problem in administering care for SCIP patients is in the SCIP-INF-4 metric. SCIP-INF-4 step 14 refers to the blood glucose level on postoperative day two (POD 2). At Step 14 the user was Unable To Determine the value. Completing such a failure cause analysis identifies a problem with the documentation procedure for blood glucose levels at this particular point in the treatment. This can prompt a hospital to review its process to see if it can be improved to reduce the number of subpar patient cases.

An object oriented meta-model to represent health care algorithms allows for more flexibility in data analysis. It provides the ability to categorize patient cases into different classes of Reason Paths that encompass all possible patient care outcomes. The power behind this approach is that it allows for the deep understanding of what led to a hospital's score.

A wide variety of other algorithms can benefit from the techniques described above, for example, other algorithms in the health care field, and particularly other algorithms in the Specifications Manual for National Hospital Quality Measures.

For instance, the Specifications Manual contains flowcharts that determine if a patient is in a given population to which the measures apply. For instance, FIGS. 21A and 21B (the NHIQM-AMI-Version 3.1) show a flowchart that determines if a patient is in the AMI population and therefore qualifies for the AMI measures. In the same fashion as for measures discussed earlier, the steps of this algorithm are annotated and given identifiers that are typically numbers.

The steps are then codified in a file just as for measures, as shown in FIG. 22.

This allows for an automatically generated explanation (reason path) of why a patient case is in a particular population in the same manner as for measures.

In the same manner as for measures and populations, the techniques can be applied to data quality checks. Prior to processing the data, the published Specifications require certain quality checks. The Specifications do not, in these examples, include flowcharts for the data quality checks as they do for measures and populations, but such flowcharts can be easily created. FIG. 23 is an example of such a flowchart that has been designed in the same style. FIG. 24 is a table that codifies the data quality algorithm of FIG. 23.

By unifying the approach for data quality, population and measures, the system provides a simple consistent interface for users to load initial data from a file, then correct and enter further data regardless of what data is being corrected or entered. Data quality, population, and measure algorithms are treated consistently and can be considered a connected set of flowcharts, thereby allowing end-users to interactively change any data regardless of what processing follows.

Another example of the application of these technique is the selection of the correct version of the algorithms to run (as illustrated, for example, in the NHIQM Specification Selection flowchart in FIG. 25). Again, FIG. 25 represents the relevant parts of the specification and can be processed in the same way to yield the codified table of steps show in FIGS. 26A and 26B.

This flowchart introduces a new step called AlgorithmStep (in effect, an embedded sub-algorithm) whose purpose is to invoke another set of algorithms as listed in the parameters section. Again an explanation can be automatically generated for an end user that describes why a particular version was chosen and why a particular set of algorithms were called.

The same technique can be applied to other algorithms, including new and different kinds of algorithms that may be encountered in health care contexts.

Other implementations are also within the scope of the following claims.

1. A computer-implemented method comprising
using a data model to express possible sequences of steps related to treatment of patients and corresponding results of respective sequences in accordance with a health care algorithm.

2. The method of claim 1 in which the data model comprises a meta-model of a real-world model that is represented by the algorithm.

3. The method of claim 1 in which the algorithm is expressed as a flowchart.

4. The method of claim 1 in which the data model is used to express such sequences and results in accordance with more than one predefined algorithm.

5. The method of claim 1 in which the data model comprises object-oriented program objects.

6. The method of claim 1 comprising
processing patient cases using the data model with respect to the treatment algorithm to determine the sequences to which the patient cases belong, and using the corresponding results to analyze causes of outcomes of the cases.

7. The method of claim 1 in which using the data model comprises expressing each of the steps as an encapsulated step object that represents a branching point of the possible sequences.

8. The method of claim 1 in which using the data model comprises including expected answers to a question that corresponds to one of the steps.

9. The method of claim 1 in which using the data model comprises including identifications of next treatment steps corresponding to respective expected answers.

10. The method of claim 1 in which using the data model comprises including a type of expected answers for questions associated with the steps.

11. The method of claim 1 in which the algorithm comprises a treatment algorithm and the steps comprise treatment steps.

12. The method of claim 1 in which the algorithm comprises steps to determine when a patient is in a given population.

13. The method of claim 1 in which the algorithm comprises steps to check quality of data.

14. The method of claim 1 in which the algorithm comprises an embedded sub-algorithm.

15. The method of claim 1 in which the data model expresses possible sequences of steps, consistently for interaction by a user, in accordance with at least two of a treatment algorithm, a data quality check algorithm, a within-population checking algorithm, and an algorithmic-choice algorithm.

16. A computer-implemented method comprising
for patients whose treatment outcomes result from sequences of treatment steps traversed through a treatment algorithm,
forming a data record for each of the patients that includes (a) the sequence of treatment steps for the patient and (b) a result of the sequence that corresponds to the outcome for the patient.

17. The method of claim 16 also including
enabling an interface user to use the data records for groups of patients whose treatments traversed respective sequences through the treatment algorithm to obtain information indicative of causes of outcomes that correspond to respective treatment sequences.

18. A medium bearing a data structure that can be used by a computer to
define possible sequences of steps related to treatment of patients and corresponding results of the respective sequences.

19. A computer-implemented method comprising
categorizing patient-treatment-related cases among a set of different possible sequences of steps and related outcomes, based on data structures that were derived from standard pre-defined sequences and outcomes, and
enabling a user to manipulate the categories of patient-treatment-related cases to infer causes of the outcomes.
